(19) United States
(12) Patent Application Publication
(10) Pub. No.: US 2005/0232074 A1
(43) Pub. Date: Oct. 20, 2005

(54) Pressurized reactor apparatus with magnetic stirring

(75) Inventors: Kenneth S. Higashihara, Cupertino, CA (US); Robert J. Saxton, Pleasanton, CA (US); Jason Wells, San Francisco, CA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Symyx Technologies, Inc., Santa Clara, CA (US)

(21) Appl. No.: 11/110,301

(22) Filed: Apr. 20, 2005

Related U.S. Application Data
(60) Provisional application No. 60/622,547, filed on Oct. 27, 2004.
(60) Provisional application No. 60/563,759, filed on Apr. 20, 2004.

(51) Int. Cl. B01F 1/00

(52) U.S. Cl. 366/273; 422/224; 422/225; 422/229

(57) ABSTRACT

An apparatus for parallel processing of reaction mixtures comprises a plurality of vessels for holding a plurality of reaction mixtures for processing. A plurality of vessel supports are adapted for supporting the plurality of vessels. Caps sealingly engage the vessel supports for sealing the vessels within the vessel supports. The vessels, vessel supports, and caps define reaction chambers having bearings and stirrers rotatable therein. The stirrers each comprise a spindle rotatable in a respective bearing and at least one stirring implement extending from the spindle for contacting a respective reaction mixture. The stirrers further comprise at least one magnet adapted to be subjected to a rotating magnetic field in the vessel for causing the stirrer to rotate thereby to mix the respective reaction mixture. The stirrers may further comprise a first magnetic follower, a second magnetic follower, and a flux guide for guiding magnetic flux between the first magnetic follower and the second magnetic follower, thereby creating a magnetic flux path between the stirrer and a respective one of a plurality of magnetic drivers coupled to the stirrers for rotating the stirrers within the vessels.

### BACKGROUND OF THE INVENTION

The present invention relates generally to reactors, and in particular, to single or parallel research reactors suitable for use in a combinatorial (i.e., high-throughput) science research program in which chemical reactions are conducted simultaneously using small volumes of reaction materials to efficiently and economically screen large libraries of chemical materials.

Reactors of this type are disclosed in co-owned International Application No. PCT/US 99/18358, filed Aug. 12, 1999, by Turner et al., entitled Parallel Reactor with Internal Sensing and Method of Using Same, published Feb. 24, 2000 (International Publication No. WO 00/09255), which is incorporated herein by reference for all purposes. This PCT application claims priority from the following co-owned, U.S. applications bearing the same title, all of which are also incorporated by reference for all purposes: U.S. application Ser. No. 09/211,982, filed Dec. 14, 1998, by Turner et al., now U.S. Pat. No. 6,306,658, issued Oct. 23, 2001; U.S. Ser. No. 09/177,170, filed Oct. 22, 1998, by Dales et al., now U.S. Pat. No. 6,548,026, issued Apr. 15, 2003; and U.S. provisional application Ser. No. 60/096,603, filed Aug. 13, 1998, by Dales et al. Reactors of the type to which the present invention relates are also disclosed in co-owned U.S. application Ser. No. 09/548,848, filed Apr. 13, 2000, by Turner et al., entitled Parallel Reactor with Internal Sensing and Method of Using Same, the U.S. national application based on the aforementioned PCT application, now U.S. Pat. No. 6,455,316, issued Sep. 24, 2002; U.S. application Ser. No. 09/239,223, filed Jan. 29, 1999, by Wang et al., entitled Analysis and Control of Parallel Chemical Reactions, now U.S. Pat. No. 6,489,168, issued Dec. 3, 2002; and U.S. application Ser. No. 09/873,176, filed Jun. 1, 2001, by Nielsen et al., entitled Parallel Semicontinuous or Continuous Stirred Reactors, which claims the benefit of U.S. provisional applications Ser. No. 60/209,142, filed Jun. 3, 2000, and Ser. No. 60/255,716, filed Dec. 14, 2000, by Nielsen et al. bearing the same title. Reactors of the type to which the present invention relates are also disclosed in co-owned U.S. application Ser. No. 10/116,861, filed Apr. 5, 2002, by Wheeler et al., entitled Combinatorial Chemistry Reactor System, which claims the benefit of U.S. application Ser. No. 09/826,606, filed Apr. 5, 2001, by Chandler, entitled Parallel Reactor for Sampling and Conducting In Situ Flow-through Reactions and a Method of Using Same, now U.S. Pat. No. 6,692,708, issued Feb. 17, 2004; and U.S. application Ser. No. 10/116,862, filed Apr. 5, 2002, by Wheeler, et al., entitled Combinatorial Chemistry Reactor System. Reactors of the type to which the present invention relates are also disclosed in co-owned U.S. application Ser. No. 10/040,988, filed Jan. 7, 2002, by Dales, et al., entitled Apparatus and Methods for Parallel Processing of Multiple Reaction Mixtures, which claims the benefit of U.S. application Ser. No. 09/772,101, filed Jan. 26, 2001, by Dales, et al., bearing the same title, now U.S. Pat. No. 6,759,014, issued Jul. 6, 2004. Reactors of the type to which the present invention relates are also disclosed in co-owned U.S. application Ser. No. 10/060,075, filed Jan. 28, 2002, by Smith et al., entitled Apparatus and Methods for Parallel Processing of Multiple Reaction Mixtures, which claims the benefit of U.S. provisional application Ser. No. 60/264,489, filed Jan. 26, 2001, by Troth et al. bearing the same title, all of which are hereby incorporated by reference for all purposes. These applications disclose a number of embodiments for parallel research reactors suitable for use, for example, in combinatorial chemistry applications, such as polymer research and catalyst research.

Many prior art processing systems use magnetically coupled stirring, but such systems typically are not capable of processing at elevated temperatures, such as those up to 350° C. (660° F.). Typically, magnetic stirring elements enclose magnets within a non-metallic coating, such as plastic, to isolate the magnets from the reaction materials. Such stirring elements are not capable of performing in high temperature reactions because the non-metallic coating is not capable of maintaining its structural integrity at elevated temperatures. Moreover, such prior art systems include magnetic stirrers loosely placed within the bottom of each reaction vessel. Such stirrers are capable of basic mixing of a reaction mixture, but are not capable of stirring highly viscous reaction mixtures, or those reaction mixtures requiring a specific type of stirrer, such as a high shear stirrer. Moreover, such stirrers are generally confined to the lower portion of the reaction vessel, which may limit their ability to stir the entire reaction mixture.

Another type of prior art magnetically-coupled stirring system uses shaft driven stirring, wherein a magnetic feed-through device couples a drive shaft with a stir shaft. Such devices suffer from various drawbacks, including increased headspace above the reaction mixture and increased wettable surface area within the reaction chamber. Such designs provide effective stirring because they are shaft driven, but the increased wettable surface area increases the likelihood of condensation within the reaction chamber, which removes materials from the reaction mixture, thereby potentially altering its chemical composition, which may alter the results of the experiment.

Other processing systems include direct drive stirring systems, wherein a drive shaft passes through an opening in the reactor for shaft stirring the reaction mixture. Such systems require an additional seal, more particularly a dynamic seal, for engaging the shaft and the opening for maintaining the reaction vessel in a sealed condition while the shaft rotates. Dynamic seals are more difficult to maintain and are less capable of performing at elevated temperatures. Moreover, these systems require an additional seal for each reactor, thereby increasing the likelihood of leaks and pressure losses due to improper sealing.

There is a need, therefore, for an improved reactor stirring system that overcomes one or more of the problems articulated above and that is well-suited for reaction temperatures up to 350° C. (660° F.), and/or which reduces the internal volume of the reactor and the amount of wettable surface within the reaction chamber, and/or which eliminates mechanical connections within the reaction chamber and seals between the moving stirrer and the stationary vessel and cap, and/or which provides for increased coupling torque between each stirrer and driver for efficiently stirring more viscous reaction mixtures. Previous reactor systems lack these capabilities.

The present invention also generally relates to systems for effecting the transfer of fluid materials, particularly reaction materials in the form of liquids and gases, to and from one or more reaction vessels of a reactor system. Such fluid transfer systems may include a probe or cannula for holding fluid material, a robot system for transporting the cannula between fluid transfer locations, including a number of reactor vessels, and hard plumbed gas conduits for transferring gaseous components to and from the vessels.

### SUMMARY OF THE INVENTION

One aspect of the present invention is directed to an apparatus for processing of a reaction mixture comprising a vessel for holding a reaction mixture for processing. A vessel support is adapted for supporting the vessel, and a cap sealingly engages the vessel support for sealing the vessel within the vessel support. The vessel, vessel support, and cap define a reaction chamber. The apparatus further comprises a bearing within the reaction chamber and a stirrer rotatable in the reaction chamber. The stirrer comprises a spindle rotatable in the bearing and at least one stirring implement extending from the spindle for contacting the reaction mixture. The stirrer further comprises at least one magnet on the stirrer adapted to be subjected to a rotating magnetic field in the vessel for causing the stirrer to rotate thereby to mix the reaction mixture.

Yet another aspect of the present invention is directed to an apparatus for parallel processing of reaction mixtures comprising a plurality of vessels for holding a plurality of reaction mixtures for processing. The apparatus further comprises a plurality of vessel supports adapted for supporting one of the plurality of vessels and caps sealingly engaging the vessel supports for sealing the vessels within the vessel supports. The vessels, vessel supports, and caps define reaction chambers having bearings within the reaction chambers and stirrers rotatable in the reaction chambers. Each of the stirrers comprises a spindle rotatable in a respective bearing and at least one stirring implement extending from the spindle for contacting a respective reaction mixture. Each of the stirrers further comprises at least one magnet on the stirrer adapted to be subjected to a rotating magnetic field in the vessel for causing the stirrer to rotate thereby to mix the respective reaction mixture.

Still another aspect of the present invention involves an apparatus for processing of a reaction mixture. The apparatus comprises a vessel adapted for holding the reaction mixture for processing and a stirring system for stirring the reaction mixture in the vessel. The stirring system comprises a stirrer contained in the vessel and a drive mechanism comprising a magnetic driver coupled to the stirrer for rotating the stirrer within the vessel. The stirrer comprises a spindle and a stirring implement on the spindle adapted to contact the reaction mixture in the vessel for stirring the reaction mixture. The stirrer further comprises a first magnetic follower, a second magnetic follower, and a flux guide for guiding magnetic flux between the first magnetic follower and the second magnetic follower. The followers and flux guide of the stirrer create a magnetic flux path between the stirrer and the magnetic driver.

Another aspect of the present invention is directed to an apparatus for parallel processing of reaction mixtures comprising a plurality of vessels sealed against fluid communication with one another and adapted for holding reaction mixtures for processing. A stirring system for stirring the reaction mixtures in the vessels comprises a plurality of stirrers contained in the vessels and a drive mechanism comprising a plurality of magnetic drivers coupled to the stirrers for rotating the stirrers within the vessels. Each stirrer comprises a spindle and a stirring implement on the spindle adapted to contact the reaction mixture in the vessel for stirring the reaction mixture. Each stirrer further comprises a first magnetic follower, a second magnetic follower, and a flux guide for guiding magnetic flux between the first magnetic follower and the second magnetic follower. The followers and flux guide of each stirrer of the plurality of stirrers create a magnetic flux path between the stirrer and a respective one of the plurality of magnetic drivers.

Yet another aspect of the present invention involves a stirring system for use in a reactor. The system comprises a vessel for holding a reaction mixture for processing. A stirrer is received in the vessel. The stirrer comprises a spindle including an upper end, a lower end, and at least two stirring elements adjacent the lower end. A first magnetic follower is sealed inside one of the at least two stirring elements, and a second magnetic follower is sealed inside another of the at least two stirring elements. The magnetic pole axis of the first magnetic follower and the magnetic pole axis of the second magnetic follower are not parallel. A drive mechanism for generating a rotating magnetic field in the vessel rotates the stirrer and thereby mixes the reaction mixture.

In still another aspect, a stirring system for use in a parallel reactor comprises a plurality of vessels for holding a plurality of reaction mixtures for processing. Stirrers are received in the vessels, each of the stirrers comprising a spindle including an upper end, a lower end and at least two stirring elements adjacent the lower end. A first magnetic follower is sealed inside one of the at least two stirring elements and a second magnetic follower is sealed inside another of the at least two stirring elements. The magnetic pole axis of the first magnetic follower and the magnetic pole axis of the second magnetic follower are not parallel. A drive mechanism for generating a rotating magnetic field in each of the plurality of vessels rotates the stirrers and thereby mixes the reaction mixtures.

In another aspect, a stirrer for use in a reactor comprises a spindle adapted to be mounted in a vessel for rotation on a longitudinal axis of the spindle. A stirring implement on the spindle is rotatable therewith for contacting a reaction mixture in the vessel. First and second magnetic followers comprise at least two spaced-apart permanent magnets rotatable with the spindle and the at least one stirring implement. A flux guide between the spaced-apart permanent magnets and rotatable therewith guides magnetic flux between the at least two spaced-apart permanent magnets. The at least two spaced-apart permanent magnets are arranged such that when they are subjected to a rotating magnetic field, the stirrer is adapted to rotate in the vessel to mix the reaction mixture.

In still another aspect, a stirrer for use in a reactor comprises a spindle adapted to be mounted in a vessel for rotation on a longitudinal axis of the spindle, a helical blade on the spindle, and at least two stirring elements projecting from the spindle. At least two magnets sealed inside the stirring elements are positioned and configured such that subjecting the magnets to a rotating magnetic field induces rotation of the stirrer.

In another aspect, an apparatus for processing of reaction mixtures comprises a base, a vessel support mounted on the base, a vessel supported by the vessel support, a cap, and a head for holding the cap. The cap is movable with the head between a first position in which the cap sealingly engages the vessel support to seal the vessel in the vessel support, and a second position in which the cap is clear of the vessel support to provide access to the vessel.

In yet another aspect, an apparatus for parallel processing of reaction mixtures comprises a base, a plurality of vessel supports mounted on the base, a plurality of vessels supported by the vessel supports, a plurality of caps, and a head for holding the caps. The caps are movable with the head between a first position in which the caps sealingly engage the vessel supports to seal the vessels in the vessel supports, and a second position in which the caps are clear of the vessel supports to provide access to the vessels.

In another aspect, an apparatus for processing of a reaction mixture comprises a reactor module comprising a reactor for containing a reaction mixture, a vessel platform for mounting the reactor, and a head movable with respect to the vessel platform. The head carries a cap corresponding to the reactor, the head being movable between a raised position and a lowered position in which the cap carried by the head sealingly engages the reactor. The apparatus further comprises an enclosure for enclosing the reactor module, the enclosure comprising a framework supporting the reactor module and walls enclosing the framework and reactor module.

In still another aspect, an apparatus for parallel processing of reaction mixtures comprises a reactor module comprising a plurality of reactors for containing the reaction mixtures, a vessel platform for mounting the plurality of reactors, and a head movable with respect to the vessel platform. The head carries a plurality of caps corresponding to the reactors and is movable between a raised position and a lowered position in which the caps carried by the head sealingly engage the reactors. An enclosure encloses the reactor module and comprises a framework supporting the reactor module and walls enclosing the framework and reactor module.

In a further aspect, a method of making and characterizing materials comprises the steps of providing vessel supports with starting materials to form reaction mixtures, confining the reaction mixture in each vessel support against fluid communication with the other vessel supports and at a pressure other than ambient pressure, stirring the reaction mixtures for at least a portion of the confining step, and controlling the temperature of the headspace within the vessel supports above the reaction mixture for at least a portion of the confining step.

In yet another aspect, apparatus for processing of a reaction mixture comprises a vessel adapted for holding a reaction mixture for processing and a stirring system for stirring the reaction mixture in the vessel. The stirring system comprises a stirrer contained in the vessel, and a drive mechanism comprising a magnetic driver coupled to the stirrer for rotating the stirrer within the vessel. The stirrer comprises a spindle and a stirring implement on the spindle adapted to contact the reaction mixture in the vessel for stirring the reaction mixture. The stirrer further comprises a first magnetic follower, a second magnetic follower, and a flux guide for guiding magnetic flux between the first magnetic follower and the second magnetic follower. The followers and flux guide of the stirrer create a magnetic flux path between the stirrer and the magnetic driver.

In still another aspect, a stirring system for use in a reactor comprises a vessel for holding a reaction mixture for processing, a stirrer received in the vessel. The stirrer comprises a spindle including an upper end, a lower end, and at least two stirring elements adjacent the lower end. A first magnetic follower is sealed inside one of the at least two stirring elements and a second magnetic follower is sealed inside another of the at least two stirring elements. The magnetic pole axis of the first magnetic follower and the magnetic pole axis of the second magnetic follower are not parallel, and a drive mechanism generates a rotating magnetic field in the vessel to rotate the stirrer and thereby mix the reaction mixture.

In another aspect, apparatus for processing of a reaction mixture comprises a vessel for holding a reaction mixture for processing, a vessel support adapted for supporting the vessel, and a cap sealingly engaging the vessel support for sealing the vessel within the vessel support. The vessel, vessel support, and cap define a reaction chamber having a bearing within the reaction chamber and a stirrer rotatable in the reaction chamber. The stirrer comprises a spindle rotatable in the bearing and at least one stirring implement extending from the spindle for contacting the reaction mixture. The stirrer further comprises at least one magnet on the stirrer adapted to be subjected to a rotating magnetic field in the vessel for causing the stirrer to rotate thereby to mix the reaction mixture.

In yet another aspect, a stirring system for use in a reactor comprises at least one vessel for holding a reaction mixture for processing. The at least one vessel has a convex bottom surface. A stirrer in the at least one vessel comprises at least one stirring element and a magnetic follower sealed inside the stirring element. A drive mechanism generates a rotating magnetic field in the at least one vessel to rotate the stirrer and thereby mix the reaction mixture. The drive mechanism comprises a rotatable magnetic driver associated with the at least one vessel to generate the rotating magnetic field in the vessel. The rotatable magnetic driver comprises a first concave surface facing the convex bottom surface of the at least one vessel. The surfaces have substantially the same shape to maintain a substantially uniform spacing therebetween.

In still another aspect, apparatus for processing of a reaction mixture comprises a vessel adapted for holding a reaction mixture for processing and a stirring system for stirring the reaction mixture in the vessel. The stirring system comprises a stirrer contained in the vessel, and a drive mechanism comprising a magnetic driver coupled to the stirrer for rotating the stirrer within the vessel. The stirrer comprises a first magnetic follower, a second magnetic follower, and a flux guide for guiding magnetic flux between the first magnetic follower and the second magnetic follower.

A stirring system for use in a reactor comprises at least one vessel for holding a reaction mixture for processing and a stirrer in the at least one vessel. The stirrer comprises first and second magnetic followers and a flux guide for guiding magnetic flux between the first magnetic follower and the second magnetic follower. A drive mechanism generates a rotating magnetic field in the at least one vessel to rotate the stirrer and thereby mix the reaction mixture.

Other objects and features will be in part apparent and in part pointed out hereinafter.

### BRIEF DESCRIPTION OF THE DRAWINGS

FIG. 1 is a perspective of one embodiment of a reactor module of the present invention;

FIG. 2 is an elevation of the reactor module of FIG. 1, portions of a cover panel being broken away to show details inside the module;

FIG. 3 is a top plan view of the reactor module of FIG. 1;

FIG. 4 is an elevation of a single reactor of the reactor module of FIG. 1;

FIG. 5 is a vertical section of a single reactor taken through line 5-5 of FIG. 3;

FIG. 6 is a perspective of a first embodiment of a stirrer of the present invention;

FIG. 7 is a section of the stirrer of FIG. 6 taken through line 7-7 of FIG. 6;

FIG. 7A is a section of the stirrer of FIG. 6 taken through line 7A-7A of FIG. 7;

FIG. 8 is an exploded perspective of a vessel/bearing/stirrer assembly of the present invention;

FIG. 9 is a perspective of a second embodiment of a stirrer of the present invention;

FIG. 10 is a section of the stirrer of FIG. 9 taken through line 10-10 of FIG. 9;

FIG. 11 is a perspective of a third embodiment of a stirrer of the present invention;

FIG. 12 is a section of the stirrer of FIG. 11 taken through line 12-12 of FIG. 11;

FIG. 13 is a perspective of a fourth embodiment of a stirrer of the present invention;

FIG. 14 is a section of the stirrer of FIG. 13 taken through line 14-14 of FIG. 13;

FIG. 15 is a perspective of a fifth embodiment of a stirrer of the present invention;

FIG. 16 is a section of the stirrer of FIG. 15 taken through line 16-16 of FIG. 15;

FIG. 17 is an exploded perspective of a magnetic driver of the present invention;

FIG. 18 is a diagram of flux flow between the magnetic driver of FIG. 17 and the stirrer of FIG. 6;

FIG. 19 is an exploded, fragmentary perspective of a head, a cap, and a cap retainer of the present invention;

FIG. 20 is bottom perspective of the cap of FIG. 19;

FIG. 21 is a section of a vent gas manifold of the present invention;

FIG. 22 is a schematic of a gas flow diagram of a fluid transfer system of the present invention;

FIG. 23 is a perspective of the reactor module of FIG. 1 with a head of the reactor in a raised position;

FIG. 24 is an elevation of the reactor module of FIG. 23;

FIG. 25 is a vertical section of the reactor module of FIG. 24 taken through line 25-25 of FIG. 23;

FIG. 26 is a partial perspective of the reactor module of FIG. 1 with a reactor cap extractor in an extracting position;

FIG. 27 is a partial perspective of the reactor module of FIG. 1 with a drip funnel installed in a single reactor;

FIG. 28 is a vertical section of a single reactor and drip funnel of FIG. 27 taken through line 28-28 of FIG. 27;

FIG. 29 is a partial perspective of a second embodiment of reaction module of the present invention with portions removed to show details;

FIG. 30 is a vertical section of a single reactor of the reactor module of FIG. 29 taken through line 30-30 of FIG. 29;

FIG. 31 is a front perspective of multiple reactor modules integrated as a parallel processing apparatus; and

FIG. 32 is a rear perspective of the parallel processing apparatus of FIG. 31.

Corresponding parts are designated by corresponding references numbers throughout the drawings.

### DETAILED DESCRIPTION OF THE INVENTION

Reactor Module Overview

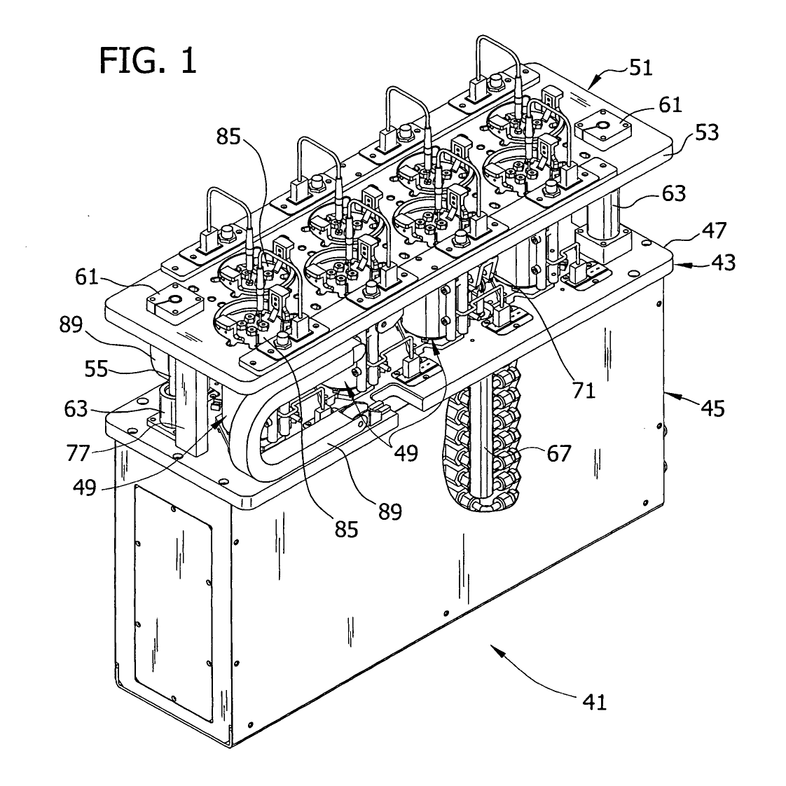

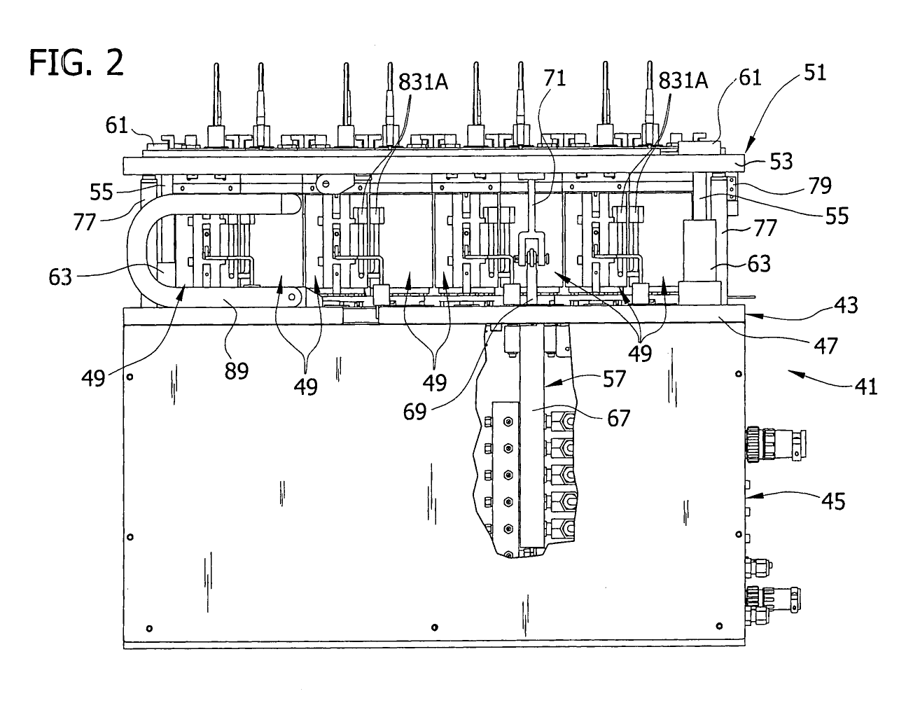

Referring now to the drawings and specifically FIGS. 1 and 2, apparatus for parallel processing of reaction mixtures is indicated in its entirety by the reference numeral 41. As used herein, in the context of methodology, the term “parallel” means that two or more of the multiple reaction mixtures are processed either simultaneously or at least during overlapping time periods. In the context of apparatus 41, the term parallel means that the apparatus is integrated structurally or through software (e.g., control software) and is adapted for effecting reactions in two or more reaction vessels simultaneously or at least during overlapping time periods. The apparatus 41, which may be referred to as a parallel reactor system, is similar in certain respects to the parallel reactor system described in the aforementioned publications and applications, including U.S. application Ser. No. 09/548,848, filed Apr. 13, 2000, now U.S. Pat. No. 6,455,316, issued Sep. 24, 2002.

As depicted generally in FIGS. 1 and 2, a reactor module, generally indicated 43, comprises a base, generally indicated 45, and a vessel platform 47 mounted on the base for mounting an N number of reactors, each generally indicated at 49. The embodiment shown and described includes 8 reactors 49, but it should be understood that N may be any number greater than or equal to one. Specifically, single reactors 49 exhibiting one or more of the reactor characteristics described herein are contemplated as within the scope of the present invention. (In the illustrated embodiment, 8 reactors are shown.) The reactor module 43 further comprises a head, generally indicated 51, movable with respect to the vessel platform 47. The head 51 of the illustrated embodiment comprises a generally flat, rectangular plate 53 supported by a pair of vertical rods 55 located adjacent diagonally opposite corners of the plate. The upper ends of the rods 55 are retained in position with respect to the head 51 via rod clamps 61. The rods 55 are slidable in rod guides 63 mounted on the vessel platform 47. The head 51 is movable up and down with respect to the vessel platform 47 and base 45 by a linear actuator, generally indicated 57 (FIG. 2). The linear actuator comprises an air cylinder 67 mounted on the underside of the vessel platform 47 having its piston rod 69 attached to the head 51 by a clevis connection 71. The air cylinder 67 is operable to be pressurized to extend the piston rod 69 for raising the head 51 to a raised position and to be depressurized to retract the piston rod for lowering the head, such as by gravity, to a lowered position. In another embodiment, the air cylinder 67 may be relocated from near the middle of the platform 47 to a corner of the platform not occupied by either vertical guide rod 55, to increase the space available for installing and removing reaction vessels, as will be discussed in greater detail below. A second air cylinder (not shown) may be mounted on a diagonally opposite corner of the plate 53 from the first air cylinder 67 to better balance forces on the head 51 when raising the head to a raised position. Other means for moving the head 51 and vessel platform 47 with respect to one another are contemplated as within the scope of the present invention.

Two stops 77 on the vessel platform 47 limit downward movement of the head 51 so that it remains spaced above the vessel platform in its lowered position. A microswitch 79 mounted on an upper end of one of these stops 77 provides a signal to the apparatus 41 to allow for heating of the vessels (discussed below), such that if the head is not in its lowered position or is moved from its lowered position during use of the reactor, no reactor heating can occur. In the embodiment shown and described, the head 51 moves with respect to the stationary vessel platform 47. However, it is contemplated that the head 51 may remain stationary while the vessel platform 47 moves up and down, without departing from the scope of the present invention. In another embodiment, the microswitch 79 may mount beneath the vessel platform 47 in a position where one of the vertical guide rods 55 engages the microswitch when the head 51 moves to its lowered position.

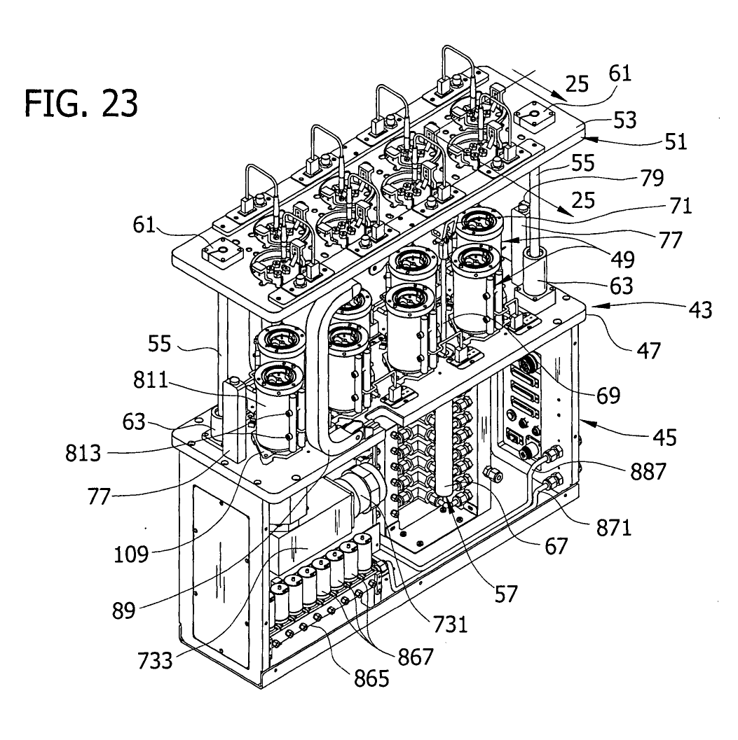

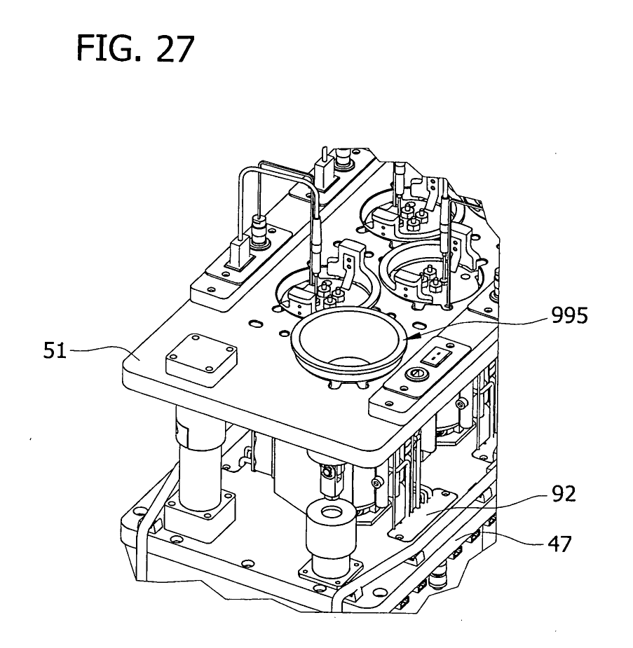

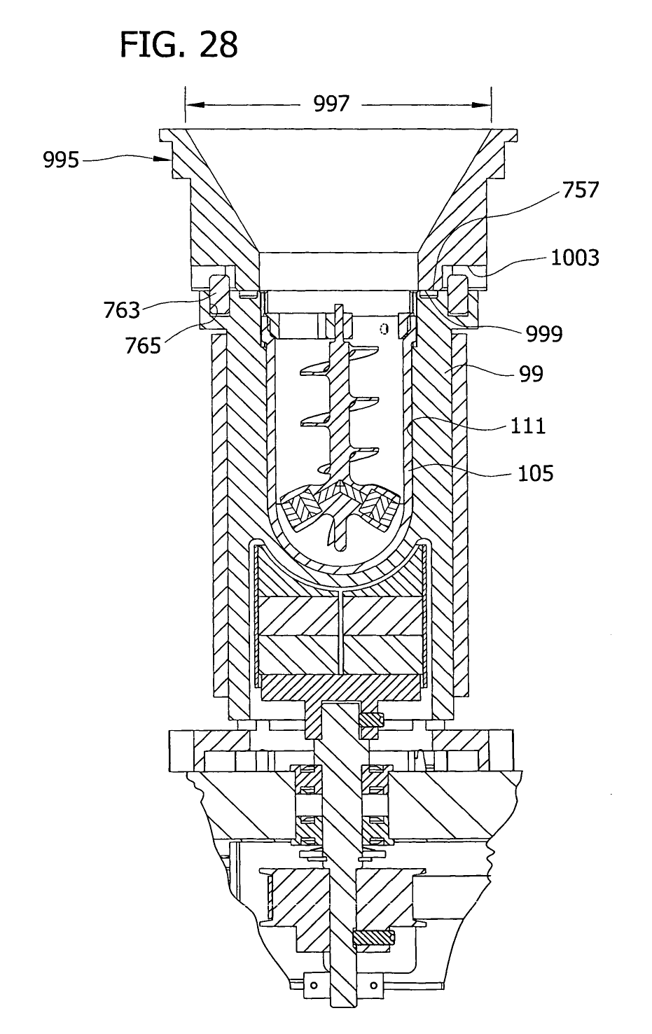

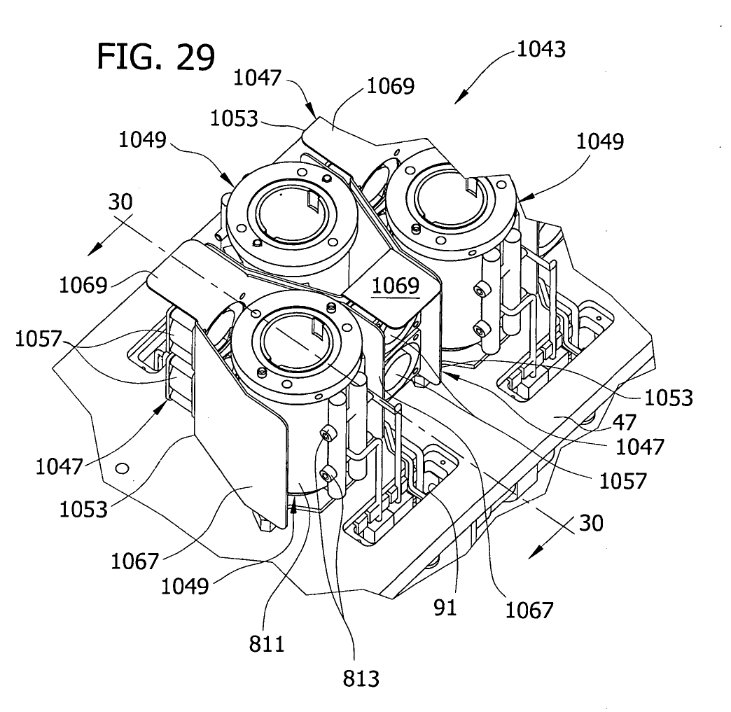

The head 51 carries, among other things, an N number of caps 85 corresponding to the N number of reactors 49, for sealing the reactors. As depicted in FIGS. 1 and 2, the head 51 rests in its lowermost position (also referred to as its sealing position) in which the caps 85 sealingly engage the reactors 49, as will be explained in greater detail below. Two articulated, flexible cable conduits 89 connect the head 51 and vessel platform 47 and act as guides for wiring connections between the base 45 and the head. As the head 51 moves toward its raised position (FIGS. 23-25), as will be discussed in greater detail below, the articulated cable conduits 89 freely move to maintain the connections between the base 45 and the head 51. Moreover, any electrical connections between the reactors 49 and the vessel platform 47 (such as those related to the heaters and fans discussed below) may be made through a series of passages 91 in the vessel platform 47, one for each reactor 49, as depicted in FIG. 29. Gas conduits, discussed below, may also pass through such passages 91 in the vessel platform 47. A cover 92 may be placed over the passage 91 to seal the passage and maintain the electrical connections and gas conduits in position within the passage (FIG. 27).

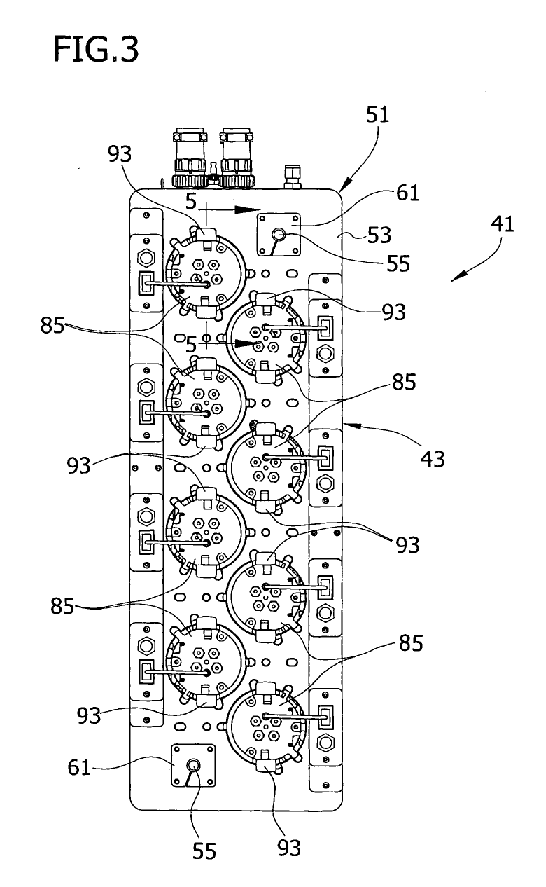

FIG. 3 is a top plan view of the reactor module 43 and shows the head 51, eight caps 85, rod clamps 61, and rods 55. In addition, the reactor module 43 comprises eight cap retainers 93 for retaining the caps 85 in position on the reactors 49, as will be explained in greater detail below.

Reactor Configuration

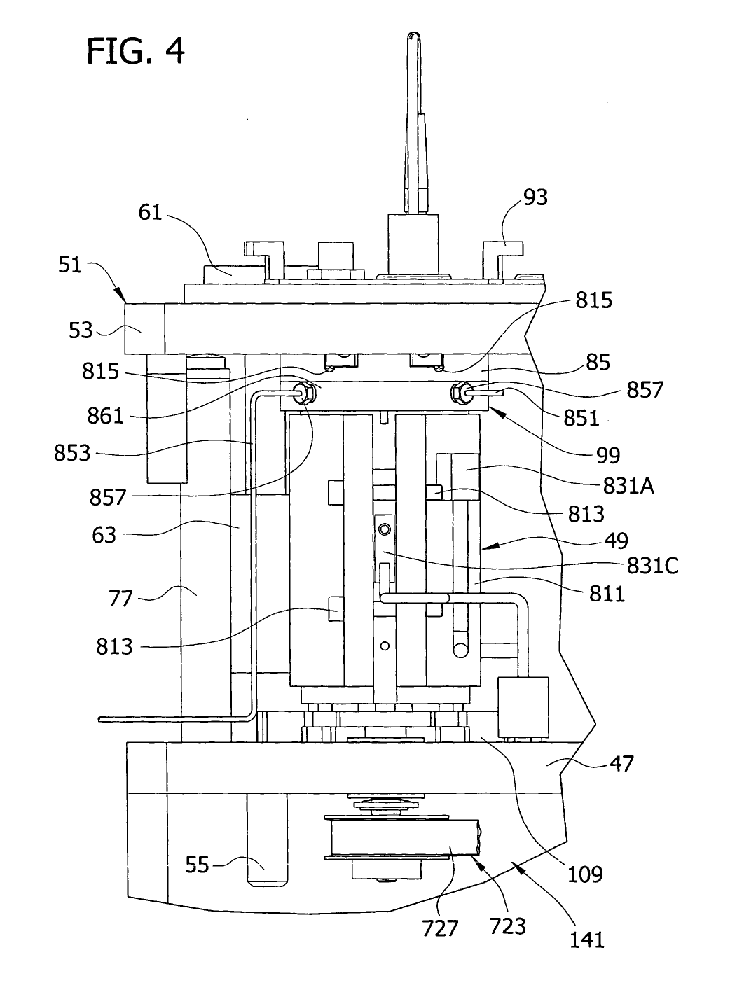

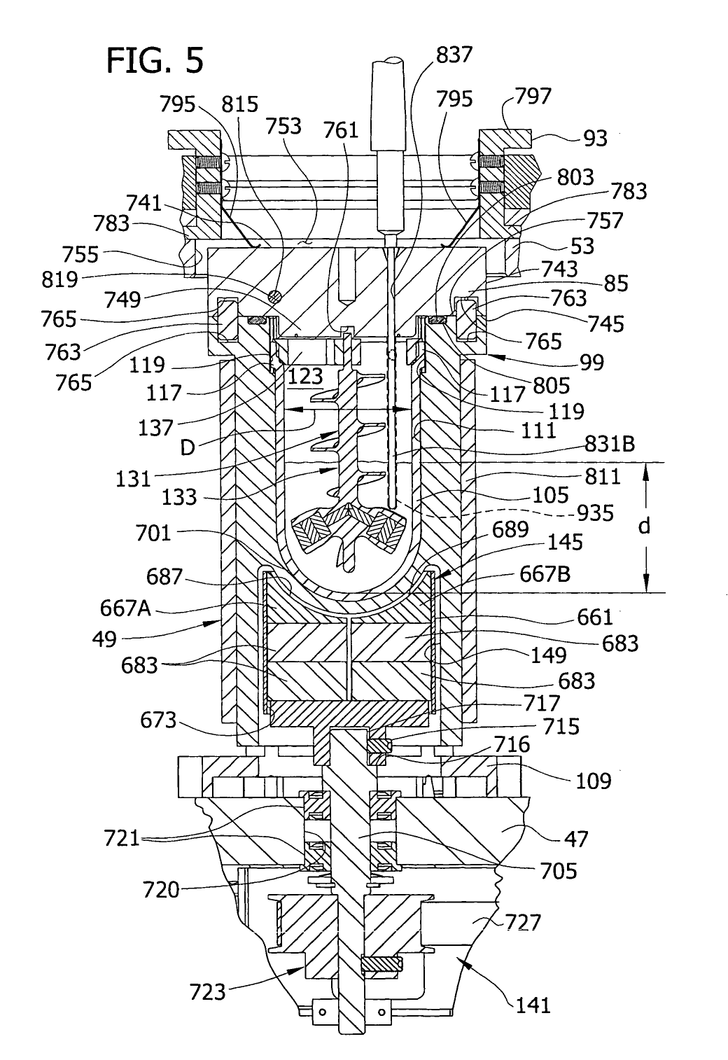

FIGS. 4 and 5 show a single reactor 49 of the reactor module 43. Each reactor 49 comprises a vessel support, generally indicated 99, having a substantially cylindric body preferably of a thermally conductive material (e.g., stainless steel), and a single vessel 105 in the body for holding a reaction mixture for processing. The vessel supports 99 of the reactor module 43 are preferably separate from one another to thermally isolate the vessels 105. Each vessel support 99 mounts on the vessel platform 47 via a reactor base 109 (see FIGS. 4, 5, and 23), thereby thermally isolating the vessel support from the vessel platform. As used herein, the term “vessel” broadly means any structure for holding reaction materials in the reactor 49. In the illustrated embodiment (FIG. 5), the vessel 105 is shown as comprising a receptacle in the form of a vial received in a well 111 extending down from the upper end of the body of the support 99. (For convenience, this receptacle will hereinafter be referred to as “vessel”, but it will be understood that the walls of the well and/or other types of liners in the well could define a vessel within the scope of this invention.) Desirably, the vessel 105 is removable from the well 111 and replaceable for ease in readying the reactor 49 for another use after a previous reaction. The vessel 105 and vessel support 99 may be keyed with respect to one another, as by keys 117 on the vessel and keyways 119 on the vessel support, for orienting the vessel with respect to the vessel support. Other vessels and vessel supports, for example, may not be keyed with respect to one another, but the user may visually align the vessel supports and vessels during assembly of the apparatus.

The vessel 105 may be made of glass or other suitably chemically inert material capable of withstanding high-temperature chemical reactions. As shown in FIG. 5, the reaction vessel 105, vessel support 99, and cap 85 cooperate to form a reaction chamber 123, which includes the volume occupied by the reaction materials and a head space above the reaction materials. The reaction chamber 123 is sealed closed by the cap 85, as will be described in greater detail below.

In the embodiment shown, the vessels 105 have a total volume of between about 10 milliliters (ml) (0.34 ounce (oz)) and about 80 ml (2.7 oz). More specifically, the vessels 105 have a total volume of between about 10 ml (0.34 oz) and about 50 ml (1.7 oz). More particularly, the vessels 105 have a total volume of between about 12 ml (0.41 oz) and about 40 ml (1.4 oz). The working volume of a particular vessel 105 is defined as the volume of the vessel 105 occupied by the reaction materials. In the embodiment shown, the vessels 105 have a working volume of between about 10 ml (0.34 oz) and about 50 ml (1.7 oz). More specifically, the vessels 105 have a working volume of between about 10 ml (0.34 oz) and about 40 ml (1.4 oz). More particularly, the vessels 105 have a working volume of between about 12 ml (0.41 oz) and about 30 ml (1.0 oz). Vessels 105 having other total volumes and other working volumes are also contemplated as within the scope of the present invention. In addition to these volumes, the vessels 105 of the depicted embodiment have particular aspect ratios that enhance the mixing of the reaction mixtures. In general, for thorough mixing much of the reaction mixture should be near the rotating stirrer, so that a large percentage of the reaction mixture is agitated during stirring. Moreover, a reaction mixture held in a substantially cylindrical vessel 105 having a mixture depth d similar in dimension to the vessel diameter D will facilitate thorough mixing by maintaining much of the reaction mixture in a substantially globular volume, wherein the maximum dimension of the reaction mixture in any direction is not substantially different than the minimum dimension of the reaction mixture in any direction. In other words, for effective mixing it is preferable that none of the reaction mixture be substantially isolated from either the rotating stirrer or other portions of the reaction mixture. By way of example, the depicted vessels 105 have an aspect ratio (length over diameter (L/D)) of less than about 4. More specifically, the vessels have an aspect ratio (L/D) of less than about 3. Even more particularly, the vessels have an aspect ratio (L/D) of less than about 2.

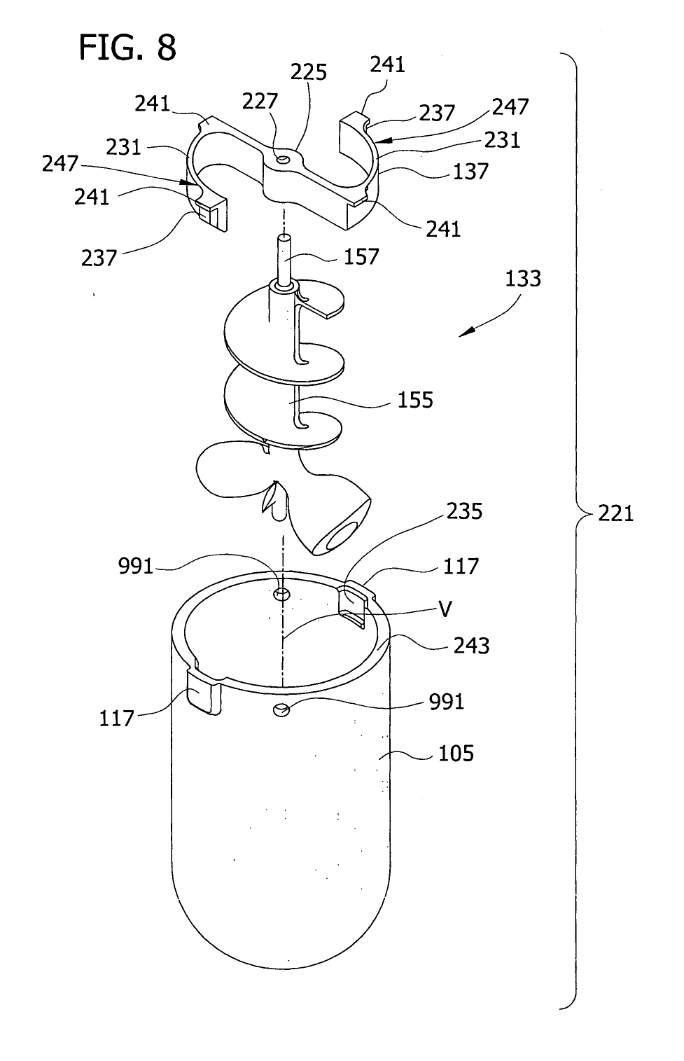

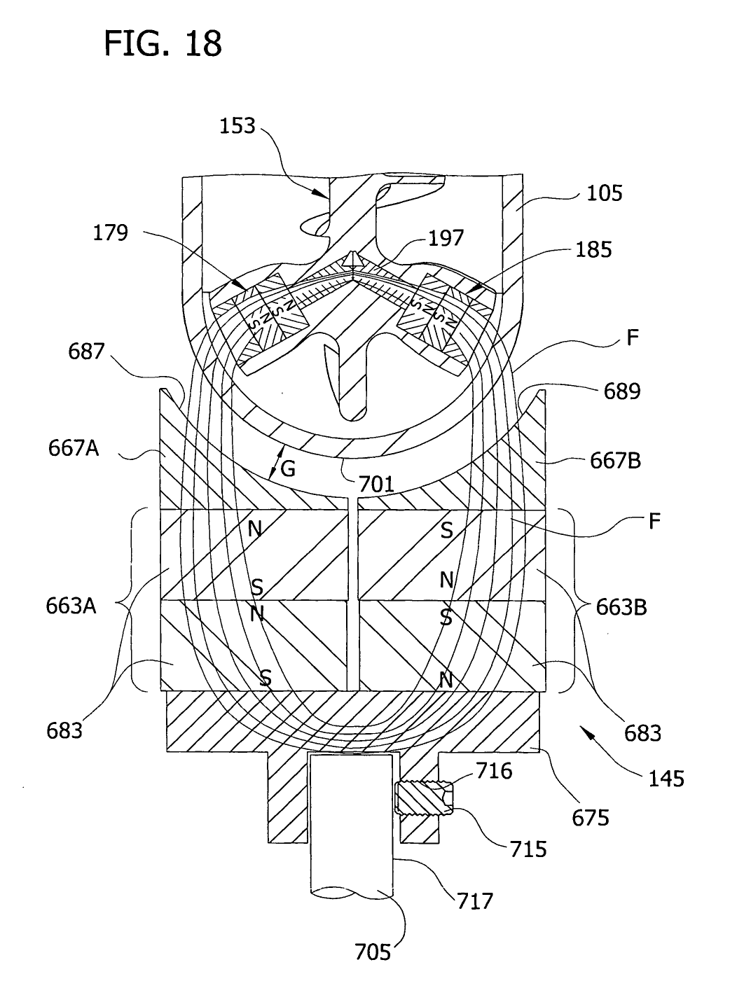

Each reactor module 43 further comprises a stirring system, generally indicated 131 (FIG. 5), for stirring the reaction mixtures in the vessels 105. The stirring system 131 comprises a stirrer 133 contained in each vessel 105 and a bearing 137 located at an upper end of each vessel within the reaction chamber 123 for mounting the stirrer for rotation within the reaction chamber, preferably (but not necessarily) on an axis coincident with the central longitudinal (vertical as shown) axis V of the vessel (FIG. 8). A drive mechanism, generally indicated 141, is provided below the vessels 105 of the reactor module 43 for rotating the stirrers 133 within the vessels. The drive mechanism 141 comprises an N number of magnetic drivers, generally indicated 145, corresponding to the N reactors 49. Each vessel support 99 includes a cavity 149 beneath the well for receiving one rotating magnetic driver 145. As will be described, each magnetic driver 145 generates a rotating magnetic flux field F (FIG. 18) in a respective vessel 105 to rotate the stirrer 133 in the vessel and thereby mix the reaction mixture.

Low Shear Stirrers

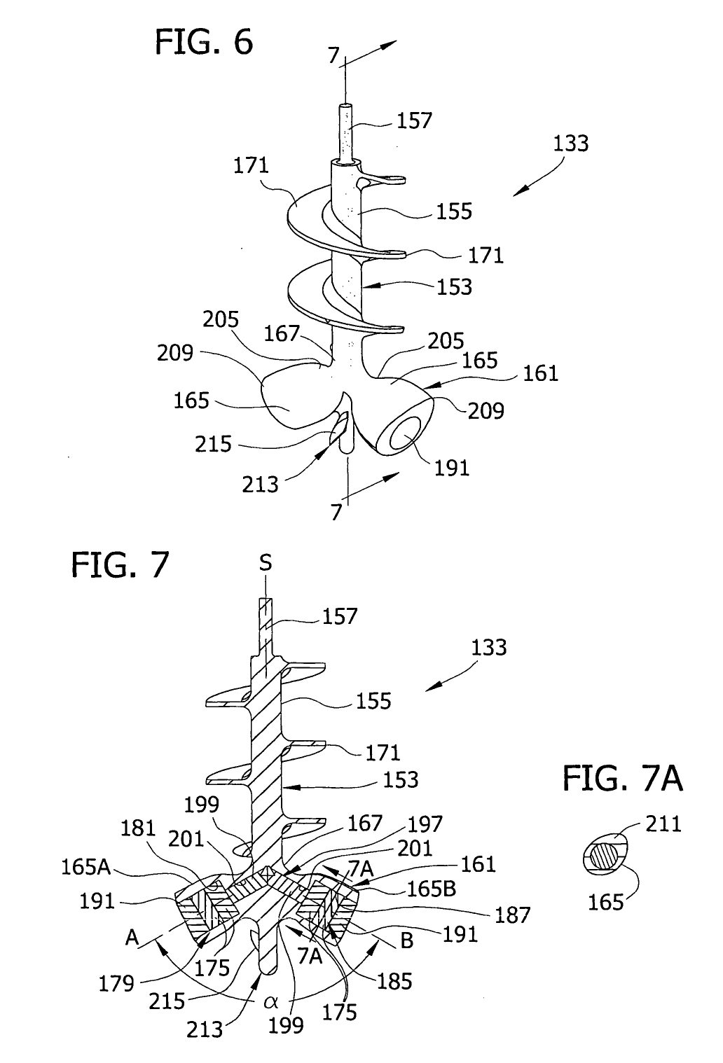

Referring now to FIGS. 6 and 7, a first embodiment of a stirrer of the present invention, generally indicated 153, is shown. The stirrer comprises a spindle 155 having an upper end 157 rotatable in a respective bearing 137 and a stirring implement, generally designated 161, comprising two stirring elements 165 extending from the spindle adjacent its lower end 167. A fewer or greater number of stirring elements 165 are contemplated as within the scope of this invention (e.g., 1, 3, 4, 5, etc.). The stirring elements 165 are positioned for contact with the reaction mixture in a vessel 105 for stirring the reaction mixture. In this embodiment, a helical blade 171 is provided on the spindle 155 for moving the reaction mixture axially along the spindle to bring any portion of the reaction mixture above the stirring elements 165 into contact with the stirring elements.

The stirrer 153 further comprises spaced apart magnets 175 mounted on the stirrer (FIG. 7). The magnets 175 provide the coupling between the stirrer 153 and the drive mechanism 141, thereby inducing rotation of the stirrer via the rotating magnetic field F. In particular, the magnets 175 are sealed inside the stirring elements 165 of the stirrer to protect them from the reaction mixture. The magnets 175 are adapted to be subjected to the rotating magnetic flux field F in the vessel 105 for causing the stirrer 153 to rotate and thereby to mix the respective reaction mixture. In the illustrated embodiment, the magnets 175 comprise a first magnetic follower, generally indicated 179, received inside a first cavity 181 in one stirring element 165A and a second magnetic follower, generally indicated 185, received inside a second cavity 187 in another stirring element 165B. In the embodiment of FIG. 7, each of the first and second followers 179,185 includes two permanent magnets 175. Although the magnets may be any suitable shape, the magnets depicted are generally cylindric. Such magnets 175 of relatively simple shape are both easily available and economical. The followers 179,185 may comprise fewer or greater number of permanent magnets 175 without departing from the scope of the present invention (e.g., 1, 3, etc.). Once the magnets 175 are placed inside the stirring elements 165, plugs 191 are inserted into the open ends of the cavities 181,187, thereby sealing the magnets within the stirring elements. The stirrer 153 and plugs 191 completely seal the magnets 175, thereby protecting the magnets from the corrosive properties of any reaction mixture stirred by the stirrer.

In addition to the first and second magnetic followers 179,185, the stirrer 153 may contain a flux guide, generally indicated 197, for guiding magnetic flux F between the first magnetic follower and the second magnetic follower. In one embodiment, the flux guide 197 comprises one or more guide elements 199 in a passage 201 in the stirrer 153 extending between the cavities 181,187 containing the magnets 175. Each of the one or more guide elements 199 need not be a permanent magnet, but may be constructed of ferromagnetic material to encourage magnetic flux F passage between the first and second magnetic followers 179,185. In one example, each guide element 199 may be constructed of steel, in particular 1018 steel having adequate ferromagnetic properties. In contrast, the stirrer 153 itself, including the spindle 155, stirring elements 165, and plugs 191, are constructed of a material with a lower magnetic flux permeability than the guide element(s) 199. This encourages magnetic flux F to travel through the permanent magnets 175 and flux guide 197 rather than through the stirrer body itself. In one example, the stirrer 153 may be constructed of stainless steel, which is a relatively low flux permeability. The use of a flux guide 197 channels flux F in a proper magnetic flux path, rather than allowing flux to travel throughout the stirrer 153. Is should be noted here that in another example, the flux guide 197 may be omitted from the stirrer 153 without departing from the scope of the present invention.

In the configuration shown, the magnetic pole axis A of the first magnetic follower 179 and the magnetic pole axis B of the second magnetic follower 185 are not parallel. In particular, an included angle it between the magnetic pole axis A of the first magnetic follower 179 and the magnetic pole axis B of the second magnetic follower 185 is one of less than and equal to about 3.1 radians (180 degrees). More particularly, the included angle α between the magnetic pole axis A of the first magnetic follower 179 and the magnetic pole axis B of the second magnetic follower 185 is one of less than and equal to about 2.6 radians (150 degrees). More particularly, the included angle α between the magnetic pole axis A of the first magnetic follower 179 and the magnetic pole axis B of the second magnetic follower 185 is one of less than and equal to about 2.1 radians (120 degrees). By orienting the magnetic pole axes A,B laterally or toward the magnetic driver 145 (downward in FIG. 5), the coupling torque between the magnetic driver and the stirrer 153 may be enhanced. These details will be discussed in detail below with respect to the magnetic driver 145.

Referring again to the geometry of the stirrer 153 of FIGS. 6 and 7, each of the stirring elements 165 has an inner end 205 adjacent the spindle 155 and an outer end 209 opposite the inner end (FIG. 6). In the embodiment shown, the axes A, B of the two stirring elements 165 lie in a common vertical plane; other configurations are possible, including those where the axes A, B lie in different vertical planes. As depicted, the inner end 205 of each stirring element 165 has a smaller cross section than the outer end 209. Moreover, the stirring elements 165 have a substantially airfoil-shaped cross section 211 throughout the length of the stirring elements (FIG. 7A). The airfoil shape 211 is beneficial because it provides improved fluid motion within the reaction mixture, in particular improved motion of the fluid axially of the spindle 155 (vertical as shown) to ensure that the entire reaction mixture is mixed thoroughly throughout the vessel 105. The shape of the airfoil 211 may be adapted to drive the reaction mixture axially of the spindle 155, up or down, depending upon the pitch of the airfoil. The shape of these stirring elements 165 can change without departing from the scope of the present invention, depending upon the desired stirring characteristics of the stirrer 153.

In addition to the stirring elements 165, the stirring implement 161 further comprises at least one paddle, generally indicated 213, extending from the spindle 155 adjacent its lower end 167. In the illustrated embodiment, the paddle 213 extends substantially perpendicular to the vertical plane containing the stirring elements 165 and includes two substantially planar blades 215 projecting laterally from opposite sides of the spindle 155 in planes that are skewed relative the longitudinal axis S of the spindle. These blades 215 ensure that the reaction materials near the bottom of the vessel 105 are adequately agitated during stirring.

As will be discussed in greater detail below, the magnetic drivers 145 beneath the vessels 105 are operable to generate rotating magnetic flux fields F in the vessels. In combination with these rotating magnetic fields F, the followers 179,185 and flux guide 197 of each stirrer 153 create a magnetic flux path (FIG. 18) between the stirrer and a respective one of the magnetic drivers 145, such that the followers of the stirrers in the vessels 105 are rotatable in response to the rotating magnetic fields to rotate the spindles 155 and stirring implements 161 to stir the reaction mixtures. In one example, the magnetic drivers 145 are configured to rotate the stirrers 153 at a speed from about 0 revolutions per minute (rpm) to about 2000 rpm. In another example, the magnetic drivers 145 are configured to rotate the stirrers 153 at a speed from about 100 rpm to about 1000 rpm. In yet another example, the magnetic drivers 145 are configured to rotate stirrers 153 at a speed from about 100 rpm to about 500 rpm.

In addition to responding to the rotating magnetic drivers 145, the stirrers 153 are also preferably capable of operation at elevated temperatures. In one example, the stirrers 153 may be capable of operation at temperatures from about 0° C. (30° F.) to about 350° C. (662° F.). More specifically, the stirrers 153 may be capable of operation at temperatures from about 20° C. (68° F.) to about 200° C. (390° F.). More particularly, the stirrers 153 may be capable of operation at temperatures from about 40° C. (100° F.) to about 160° C. (320° F.). Operating at such temperatures requires a stirrer 153 formed of a material stable at high and low temperatures, such as stainless steel.

In another example, the stirrer 153 may be formed from other materials, such as a chemically-resistant plastic, like polyethylethylketone (PEEK), polytetrafluoroethylene (PTFE), and the like. Such stirrers 153 may be capable of operation at temperatures from about 0° C. (300° F.) to about 200° C. (390° F.). More specifically, the stirrers 153 may be capable of operation at temperatures from about 20° C. (68° F.) to about 170° C. (340° F.). More particularly, the stirrers 153 may be capable of operation at temperatures from about 40° C. (100° F.) to about 150° C. (300° F.). In still another example, the stirrer 153 and/or the magnetic followers 179,185 may be Teflon-encapsulated for isolation from the reaction mixture.

In addition to the temperature considerations associated with the integrity of the stirrer material at elevated reaction temperatures, the magnetic performance of the permanent magnets within the stirrer may also be considered during magnet selection.

Instead of the stirrer 153 described above, the vessels 105 may also receive conventional magnetic stir bars (not shown) for driving rotation by the rotating magnetic fields F described above. Such stir bars may include a single permanent magnet, or first and second magnetic followers, generally as set forth above. The single permanent magnet or magnetic followers may be Teflon-encapsulated for isolation from the reaction mixture.

Vessel/Bearing/Stirrer Assembly

Turning to FIG. 8, the vessel 105, bearing 137, and stirrer 133 of the present invention are shown in greater detail, and may be considered a unit, namely a vessel/bearing/stirrer assembly 221. One such assembly is received in each of the plurality of vessel supports 99. Further, each assembly 221 is removable from a respective vessel support 99 as a unit when a reaction is complete. Another vessel/bearing/stirrer assembly 221 may then replace the used assembly for the next experiment. The use of such assemblies 221 allows for preloading of reactants into an assembly before an experiment. By preloading the reactants and replacing the entire assembly 221 as a unit after each experiment, the turn-around time between reactions is streamlined. When a reaction is complete, entire assemblies 221 may be removed and replaced with new assemblies having clean stirrers 133 and vessels 105, as well as new starting reactants.

Each assembly 221 comprises a bearing 137 having a hub 225 including an opening 227 for rotatably receiving a portion (upper end 157) of the rotatable spindle 155 of a respective stirrer 133. The upper end 157 of the rotatable spindle 155 freely rotates within the opening 227 in the bearing 137, thereby orienting the stirrer 133 and bearing with respect to one another. The bearing 137 additionally comprises two arms 231 extending radially outward from the hub 225 for engagement with the vessel 105 to support the bearing within the vessel 105. To accommodate these arms 231, the vessel 105 includes two recesses 235 for receiving corresponding registration members 237 located at the outer ends of the arms of each bearing 137. These registration members 237 locate the bearing 137 within the vessel 105 in a generally circumferential direction. In addition, the bearing 137 includes support members 241 extending from the arms 231 for engaging an upper rim 243 of the vessel 105 for locating the bearing in a generally axial (vertical as shown) direction with respect to the vessel. Thus, the arms 231, registration members 237, and support members 241 cooperate to secure and orient the bearing 137 and stirrer 133 within the vessel 105. In one embodiment, the arms 231 are resilient and have curved end portions, generally indicated 247 in FIG. 8, which are adapted to be flexed toward one another for placement of the bearing 137 in the vessel 105. After such placement, the arms 231 are released, causing the end portions 247 to spring out against the vessel 105 to secure the bearing 137 in place. The bearing and vessel 105 may include a greater or fewer number of arms 231 and recesses 235, respectively, without departing from the scope of the present invention. Moreover, the bearing 137 may be held within the vessel 105 by other means altogether, without departing from the scope of the present invention. It is also contemplated that the vessel may not include any recesses for receiving corresponding registration members located at the outer ends of the arms of each bearing without departing from the scope of the claimed invention. Instead, the user may visually align the bearing with respect to the vessel.

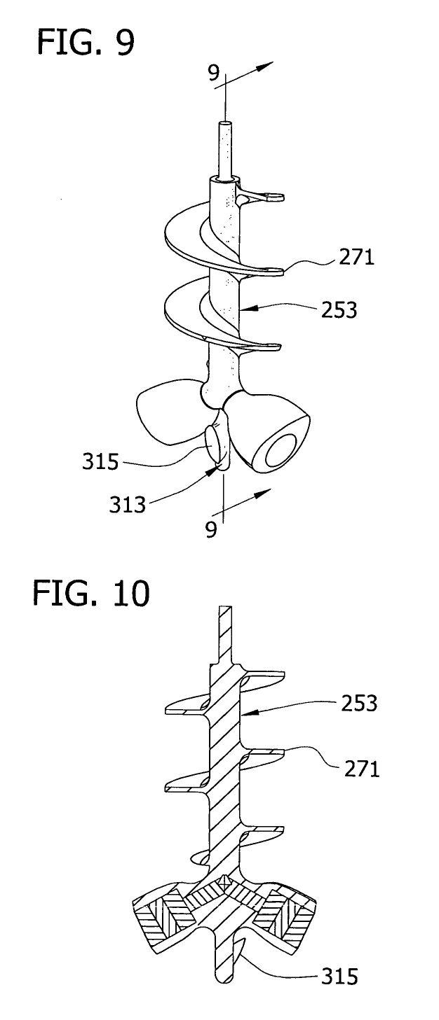

Referring now to FIGS. 9 and 10, another stirrer embodiment of the present invention is generally indicated at 253. This stirrer 253 is similar to the stirrer 153 of FIGS. 6 and 7 except that the blades 315 of the paddle, generally indicated 313, are angled in a direction opposite the previous stirrer configuration. (As viewed in FIG. 6, the blades 215 are tilted slightly clockwise; as viewed in FIG. 9, the blades 315 are tilted slightly counterclockwise.) The functioning of the stirrers 153,253 is similar, except that the paddle 313 of the stirrer 253 of FIGS. 9 and 10 directs the reaction mixture in the same general direction as the helical blade 271, while the paddle 213 of the stirrer 153 of FIGS. 6 and 7 directs the reaction mixture in a generally opposite direction. In other respects, the stirrers 153, 253 are substantially similar.

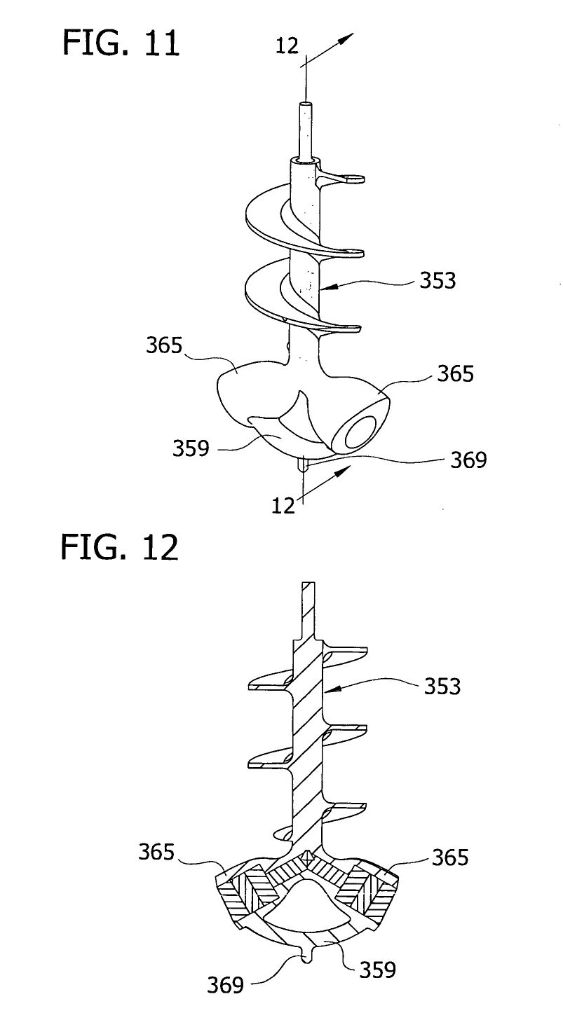

FIGS. 11 and 12 illustrate yet another stirrer of the present invention, generally indicated 353. This stirrer is similar to the stirrers 153,253 of FIGS. 6 and 7 and FIGS. 9 and 10, respectively, except that the stirrer includes a downwardly directed bridge 359 extending between the stirring elements 365, rather than the paddles 213,313 of the previous stirrers. The purpose of the bridge 359 is to further enhance stirring of the reaction mixture near the bottom of the vessel 105. A support 369 extends downward from the bridge 359 for contact with the bottom of the vessel 105 to support the stirrer 353 in the vessel.

High Shear Stirrer

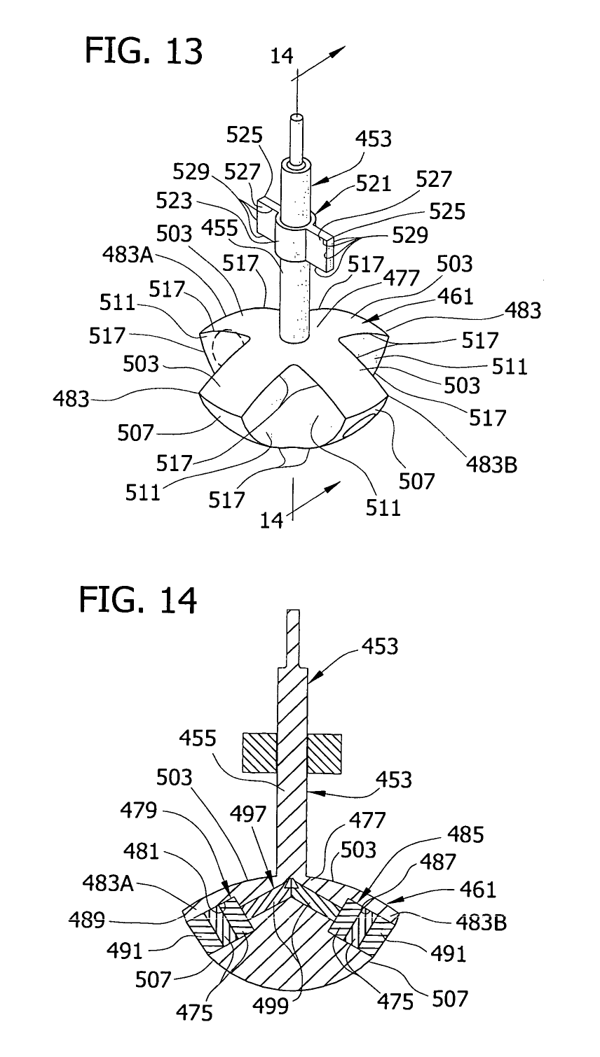

Still another stirrer of the present invention, generally indicated 453, is depicted in FIGS. 13 and 14. This stirrer 453 is configured for producing high shear forces within the reaction mixture, in contrast to the relatively low shear forces produced by the stirrers 153,253,353 described above. High shear stirrers are particularly useful for breaking apart bubbles and globules within the reaction mixture. The low shear stirrers disclosed above are more useful for standard stirring of materials that more easily break up and mix with one another. Moreover, shear rate may affect crystal growth within the reaction mixture. In particular, lower shear forces may reduce the fragmentation of the reaction mixture due to collisions, while higher shear forces may increase the fragmentation of the reaction mixture. By controlling the shear rate within the reaction mixture, different material phases may be formed from the same reaction mixture.

The high shear stirrer 453 of FIGS. 13 and 14 comprises a stirring implement, generally indicated 461, that surrounds permanent magnets 475, generally as set forth above, except that the stirrer configuration yields high shear stirring within the reaction mixture. The stirring implement 461 comprises a hub 477 on the spindle 455 and a number N of mixing arms 483 projecting generally laterally and preferably radially from the hub. In the embodiment shown, four mixing arms 483 are arranged at regular intervals of about 1.6 radians (90 degrees) around the hub 477, but it will be understood that the number of mixing arms may vary from one to two or more. It is further contemplated that the mixing arms 483 may be spaced at other regular internals or even irregular intervals without departing from the scope of the present invention. A first mixing arm 483A oriented in a first lateral direction encloses a first magnetic follower, generally indicated 479, comprising at least two permanent magnets 475 within a first cavity 481 extending inward from an outer end 489 of the mixing arm. A second mixing arm 483B oriented in a second lateral direction generally opposite the first lateral direction encloses a second magnetic follower, generally indicated 485, comprising another at least two permanent magnets 475 within a second cavity 487 similar to the first cavity 481. Once the permanent magnets 475 are placed inside the cavities 481,487 of the mixing arms 483, plugs 491 are inserted into the outer ends of the cavities to seal the magnets within the arms. The stirrer implement 461 body and plugs 491 completely seal the magnets 475 within the stirrer 453, thereby protecting the magnets from the corrosive properties of any reaction mixture stirred by the stirrer. The permanent magnets 475 in the first mixing arm 483A are spaced apart from the permanent magnets in the second mixing arm 483B. In addition to the permanent magnets 475, the stirrer 453 contains a flux guide, generally indicated 497, comprising flux guide elements 499 for guiding magnetic flux between the first magnetic follower 479 and the second magnetic follower 485, substantially as set forth above with respect to the previously described stirrers 153,253,353. In one example, the flux guide elements 499 may be constructed of ferromagnetic material (e.g., 1018 steel) to encourage magnetic flux F flow between the magnetic followers 479,485. Is should be noted here that in another example, the flux guide 497 may be omitted from the stirrer 453 without departing from the scope of the present invention. In addition, the permanent magnet 475 may be formed from a single permanent magnet, rather than two or more.

The mixing arms 483 of the stirrer 453 are configured to develop high shear forces during stirring. In the illustrated embodiment, each arm 483 has a convex top face 503 curving down from the central hub 477 of the stirrer 453, a convex bottom face 507 curving down from the outer end of the top face to the central hub of the stirrer, and a pair of flat, opposing side surfaces 511 lying in generally parallel planes extending generally axially of the stirrer. (In other words, the side surfaces 511 are oriented substantially perpendicular to a circular path traced by the mixing arm 483 as the stirrer 453 rotates.) The top face 503, bottom face 507, and side faces 511 intersect along relatively sharp, angular, abrupt edges 517 that, during stirring, slice through the reaction mixture, thereby creating high shear forces within the reaction mixture. Further, the relatively broad, flat side faces 511 of the mixing arms 483 contact a substantial volume of material as they sweep through a rotation to effect substantial mixing of the reaction mixture. Such a high shear stirrer 453 may be useful in dispersing components within the reaction mixture, such as with micro-emulsions. The stirrer 453 further comprises a paddle, generally indicated 521, mounted on the spindle 455 at a location above the stirring implement 461. The paddle 521 includes a central sleeve 523 surrounding the spindle 455, and a pair of blades 525 projecting radially outward from the sleeve 523 in opposite directions. The blades 525 have broad, substantially planar side faces 527 oriented substantially perpendicular to the circular path followed by the paddle 521 as it rotates. The upper, lower, and outer edges 529 of the blades 525 are also sharp (angular, abrupt) for creating high shear forces within the reaction mixture during rotation.

The stirrer 453 may be constructed of chemically-resistant plastic material, such as a perfluoro-elastomer, a polyethylethylketone, or a polytetrafluoroethylene, for example. The stirrer 453 may also be constructed of a material stable at high temperatures, such as stainless steel.

Uniform Low Shear Stirrer

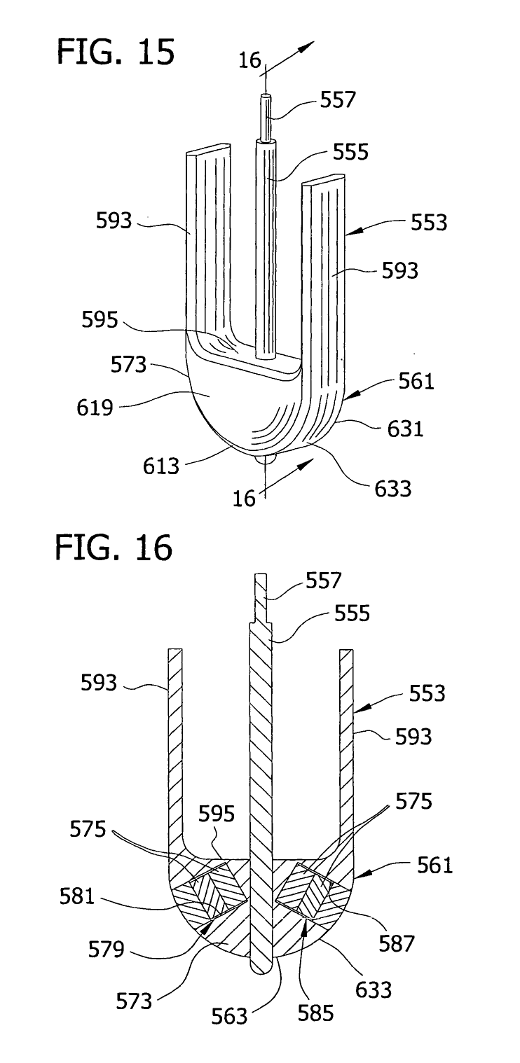

Yet another stirrer of the present invention, generally indicated 553, is depicted in FIGS. 15 and 16. This stirrer 553 is configured for producing uniform low shear forces within the reaction mixture. The stirrer 553 comprises a spindle 555 having an upper end 557 rotatable in a respective bearing 137 and a stirring implement, generally designated 561. The stirring implement is substantially U-shaped, such that a bottom 563 of the U-shaped stirring implement is adjacent a bottom end of the spindle 555. The stirring implement 561 comprises a semi-circular base 573 and two, or more, upstanding arms 593, generally parallel to the spindle 555, extending up from the base. The base 573 has a flat, generally rectangular upper surface 595 perpendicular to the spindle 555 and a pair of side faces 619 extending down from respective side edges of the upper surface 595 in planes generally parallel to the spindle. These side faces 619 have substantially semicircular bottom edges 631. The stirring implement 561 has a curved bottom surface 633 that extends between these substantially semicircular bottom edges 631. The rectangular upper surface 595, opposing side faces 619, and curved bottom surface 633 define the base 573 of the stirring implement 561. The arms 593 extend up from opposing end edges of the rectangular upper surface 595 of the base 573 and are generally rectangular in cross section. The stirring implement 561 is positioned for contact with the reaction mixture in a vessel 105 for stirring the reaction mixture.

The stirrer 553 further comprises spaced apart magnets 575 mounted on the stirrer. The magnets 575 provide the coupling between the stirrer 553 and the drive mechanism 141, thereby inducing rotation of the stirrer via a rotating magnetic field F. In particular, the magnets 575 are sealed inside the base 573 of the stirring implement 561 to protect them from the reaction mixture. The magnets 575 are adapted to be subjected to a rotating magnetic field F in the vessel 105 for causing the stirrer 553 to rotate and thereby to mix the respective reaction mixture. In the illustrated embodiment, the magnets 575 comprise a first magnetic follower 579 received inside a first cavity 581 of the stirring implement 561 and a second magnetic follower 585 received inside a second cavity 587 of the stirring implement substantially as set forth above. Although not shown, another example of the stirrer 553 may additionally contain a flux guide for guiding magnetic flux between the first magnetic follower 579 and the second magnetic follower 585. In yet another example, the spaced apart magnets 575 may comprise a single permanent magnet.

Drive Mechanism

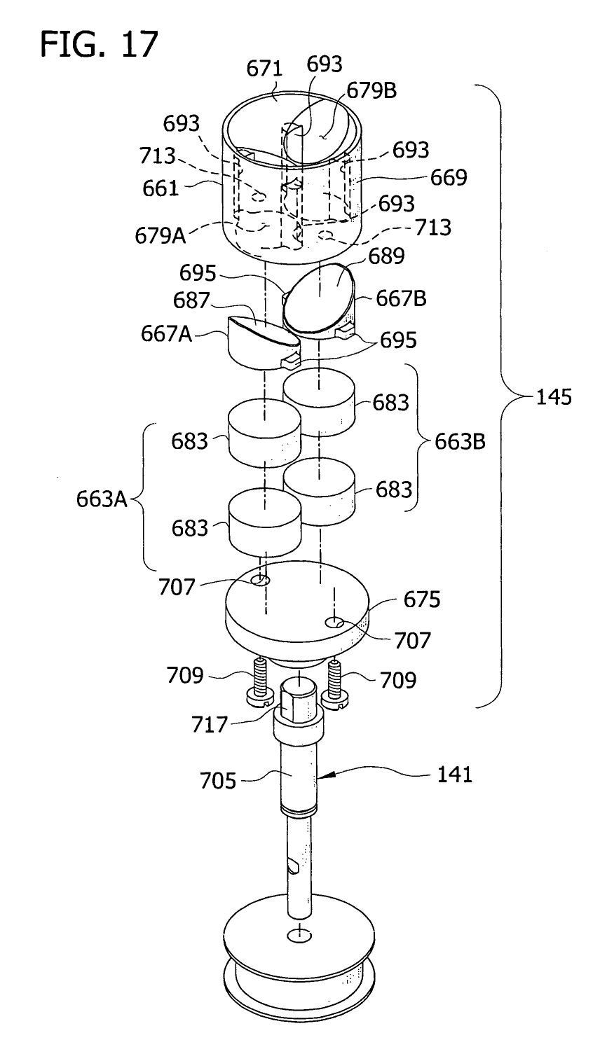

In general, each magnetic driver 145 of the drive mechanism 141 for rotating the stirrers 133 comprises a driver framework 661, at least one magnetic driver element 663 in the driver framework, and at least one flux guide 667 in the driver framework for guiding magnetic flux F between the magnetic driver element and the stirrer. In one embodiment (FIGS. 5 and 17), the driver framework 661 comprises a cylindric housing 669 having an upper surface 671, a recessed lower end 673 for receiving a driver base 675, and a pair of spaced apart cavities 679 extending generally vertically down from the upper surface of the housing to the base. First and second magnetic driver elements 663A,663B are received in respective first and second cavities 679A,679B, each such element comprising a north-seeking pole N and a south-seeking pole S (FIG. 18).

The poles of the first and second magnetic driver elements 663A,663B are oriented substantially opposite with respect to one another, as depicted in FIG. 18. This arrangement creates a magnetic flux field F between the first and second magnetic driver elements 663A,663B. In one embodiment, the first magnetic driver element 663A comprises two or more permanent magnets 683 stacked one above the other, and the second magnetic driver element 663B comprises two or more permanent magnets 683 stacked one above the other. A fewer or greater number of magnets 683 may be incorporated into the driver elements 663 without departing from the scope of the present invention. The magnetic followers (e.g., 179,185) of the stirrers 153 (FIGS. 7, 10, 12, and 14) similarly comprise a north-seeking pole N and a south-seeking pole S (see, FIG. 18). Either the north-seeking pole N or the south-seeking pole S of the first magnetic driver element 663A is oriented substantially toward an oppositely seeking pole of the first magnetic follower 179. Similarly, the second magnetic driver element 663B, which has its poles oriented opposite the first magnetic driver element 663A, has its opposite pole oriented substantially toward an oppositely seeking pole of the second magnetic follower 185.

A first flux guide 667A is received in one cavity 679 of the framework 661 above the first magnetic driver element 663A for guiding flux F toward the first magnetic follower 179 of the stirrer 153, and a second flux guide 667B is similarly situated in the other framework cavity atop the second magnetic driver element 663B for guiding flux toward the second magnetic follower 185 of the stirrer. The first and second flux guides 667A,667B include first and second concave surfaces 687,689, respectively, shaped and sized to face the vessel 105 and vessel support 99. In addition, the upper surface 671 of the driver framework 661 is also concave and has about the same radius of curvature as the upper concave surfaces 687,689 of the flux guides 667. The first cavity 679A and the first flux guide 667A are keyed with respect to one another for orienting the first flux guide with respect to the driver framework 661. The second cavity 679B and the second flux guide 667B are similarly keyed with respect to one another. In particular, the sidewall of each cavity 679 of the driver framework 661 includes a pair of opposed channels 693 extending lengthwise of the cavity (vertically as shown in FIG. 17) for receiving corresponding orientation tabs 695 on a respective flux guide 667. These tabs 695 orient the flux guides 667 with respect to the driver framework 661 and hold the flux guides in the proper orientation during driver 145 rotation. In addition, the channels 693 are closed at their upper ends for vertically locating the flux guides 667 within the cavities 679. With the orientation tabs 695 located at the upper end of the channels 693, the first and second concave surfaces 687,689 of the flux guides 667 lie substantially flush with the upper concave surface 671 of the driver framework 661 (see FIG. 18). The first and second flux guides 667 are constructed of a ferromagnetic material, such that they easily direct magnetic flux F toward the stirrer 153. In one example, the flux guides 667 may be constructed of steel, such as 1018 steel.

In the embodiment shown in FIGS. 5 and 18, the vessel 105 has a curved (e.g., hemispherical) bottom 701 facing the magnetic driver 145. Preferably, the first and second concave surfaces 687,689 of the magnetic driver 145 and the concave upper surface 671 of the framework have curvatures generally corresponding to that of the vessel bottom 701. By configuring the vessel bottom 701 and magnetic driver 145 to have substantially the same shape, the spacing G, or gap, between the bottom of the vessel and the concave surfaces 687,689 of the magnetic driver is maintained substantially uniform. This spacing G remains substantially uniform as the magnetic driver 145 rotates. By way of example, the spacing G (i.e., the distance between the concave surfaces 687,689 and the vessel bottom 701) may range from about 1 millimeter (mm) (0.04 inch (in)) to about 10 mm (0.4 in). More particularly, the spacing G may range from about 2 mm (0.08 in) to about 5 mm (0.2 in).

Thus, the magnetic driver 145 and stirrer 153 cooperate to create a strong magnetic field, having flux F flowing along a magnetic flux path (FIG. 18) through the first magnetic driver element 663A, the first flux guide 667A, the first magnetic follower 179, the stirrer flux guide 197, the second magnetic follower 185, the second flux guide 667B, the second magnetic driver element 663B, and back to the first magnetic driver element. It should be understood by one skilled in the art that the magnetic flux F may travel in either direction without departing from the scope of the present invention. Preferably, the first and second concave surfaces 687,689 of the flux guides 667 are angled upward toward the stirrer 153, and the first and second magnetic followers 179,185 are directed downward toward the magnetic driver 145 (FIG. 18). By directing these components toward one another, less magnetic flux F is lost due to misdirection, thereby enhancing the coupling torque between the magnetic driver 145 and the stirrer 153. Moreover, shaping the first and second flux guides 667A,667B to match the shape of the vessel bottom 701 minimizes the spacing G between the magnetic driver 145 and the magnetic followers 179,185 of the stirrer 153, thereby further reducing the amount of lost flux F.

The permanent magnets 683 may be constructed of Samarium Cobalt Grade 28, Grade 18, or Grade 20 magnetic materials. Other rare earth or permanent magnetic materials are also contemplated as within the scope of the present invention. In one example, magnet selection may be influenced by the temperature requirements of the reactor. Moreover, the driver framework 661 is specifically configured to resist transmitting magnetic flux F. In particular, the driver framework 661 is constructed of a material having a low magnetic flux permeability, such as aluminum.

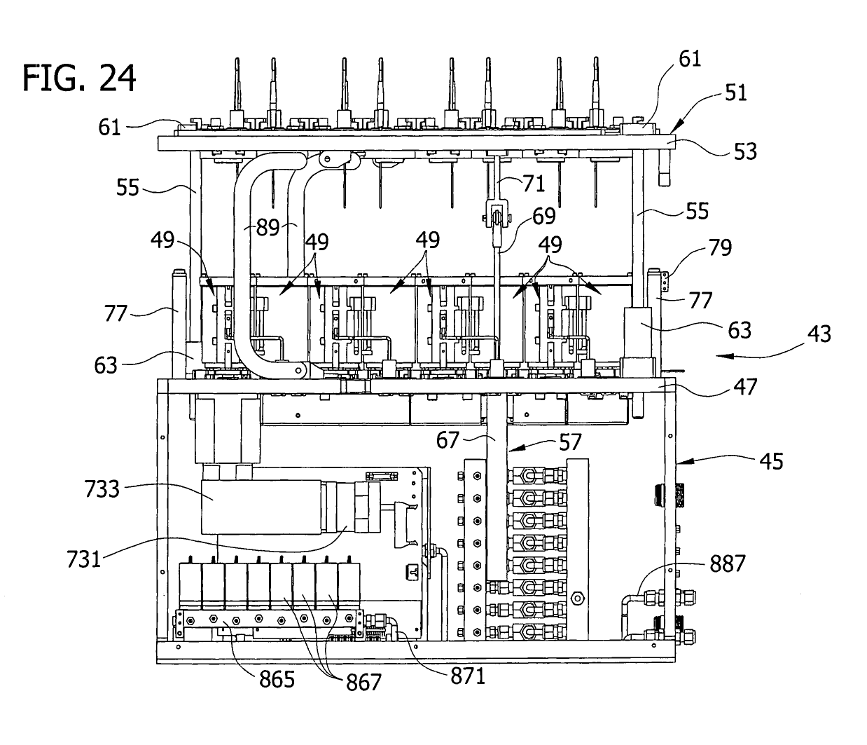

Each magnetic driver 145 further comprises a drive shaft 705 connected to the driver base 675 for rotating the driver base and driver framework 661 (FIGS. 5 and 17). The driver base 675 includes holes 707 for receiving fasteners 709 that thread into corresponding threaded holes 713 in the bottom of the driver framework 661 to fasten the driver framework to the driver base. The drive shaft 705 is secured to the driver base 675 via a set screw 715 threaded into an opening 716 in the driver base and engaging a flat 717 on the drive shaft (FIGS. 5 and 17). The drive shaft 705 extends down from the driver base 675 and is journalled in a bearing 721 (FIG. 5) mounted in an opening 720 in the vessel platform 47. A drive train, generally indicated 723, couples with each of the drive shafts 705 of the various magnetic drivers 145 for rotating the drive shafts, the magnetic drivers, and ultimately the stirrers 133. As illustrated in FIGS. 4 and 5, the drive train 723 comprises a belt and pulley system 727 coupled to the drive shafts 705 and a motor 731 (FIGS. 23 and 24) that drives the belt and pulley system. In one embodiment, the drive mechanism 141 further comprises a gearbox 733 coupled to the motor 731 and the belt and pulley system 727 for driving the belt and pulley system at a speed different from (e.g., one half of) the speed of the motor. In another embodiment, the motor 731 may be a variable speed motor for altering the speed of the drive train 723 and stirrers 133. Moreover, the belt and pulley system 727 may be configured such that the magnetic drivers 145 and stirrers 133 rotate in the same direction. In one example, the motor 731 may be under the control of a suitable controller, such as a computer, comprising software or hardware for controlling the operation of the motor, which ultimately controls the stirrers 133.

It will be understood that the magnetic drivers 145 may be rotated by other types of drive mechanisms 141, such as chain drives, gear drives, etc. Also, each magnetic driver 145 may be rotated by an independent drive system (e.g., individual reactor motors) so that the rotational speed of the corresponding stirrer 133 can be varied independent of the speed of the other stirrers.

Vessel Sealing

Turning to FIGS. 5, 19, and 20, the interaction of the head 51, cap retainer 93, cap 85, and vessel support 99 of the invention is shown. The sealing engagement of the caps 85 and vessel supports acts 99 to seal the vessels 105 within the vessel supports. Once sealed, each vessel 105, vessel support 99, and corresponding cap 85 define the sealed reaction chamber 123, as discussed above. In the embodiment illustrated in FIGS. 5, 19, and 20, each cap 85 is generally circular in shape, having a flat top surface 741, a cylindric side wall 743 and an annular bottom surface 745 surrounding a central downwardly projecting boss 749. The head 51 has an opening 753 therein for receiving each such cap 85, the opening being defined by an axial wall indicated at 755. The annular bottom surface 745 of the cap 85 is adapted to rest on a top surface 757 of a respective vessel support 99 when the cap is received in the head opening 753 as shown in FIG. 5. In this position, the boss 749 on the underside of the cap 85 (FIG. 20) extends down into the upper end of a respective well 111 in the vessel support 99 to a position immediately adjacent the stirrer bearing 137 so that the bearing is held in a substantially self-retained vertical position (FIG. 5). The boss 749 has a blind bore 761 therein for receiving the upper end 157 of the spindle projecting above the bearing 137. In the illustrated embodiment, the cap 85 and vessel 105 are held in self-retained circumferential position relative to one another by a plurality of keys 763 received in mating keyways 765 in the top surface 757 of the vessel support 99 and the annular bottom surface 745 of the cap. The number of keys 763 (or other alignment devices) used may vary.

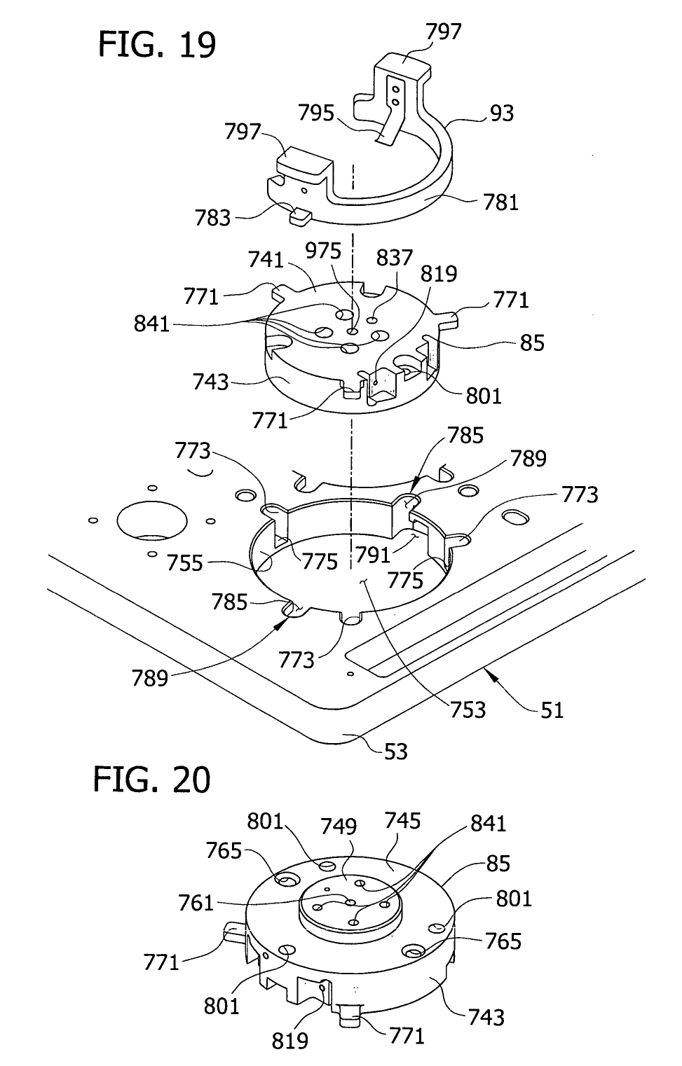

As best shown in FIGS. 19 and 20, means is also provided for insuring proper orientation of the caps 85 relative to the head 51. This means comprises a number of registration elements 771 on the cap 85 and a number of cooperating registration elements 773 on the head 51. In one embodiment, the registration elements 771 on the cap 85 comprise at least two locking tabs (also numbered 771) projecting laterally out from the side wall 743 of the cap adjacent the top surface 741 of the cap, and the registration elements 773 on the head 51 comprise a corresponding number of recesses (also numbered 773) for receiving the locking tabs. By way of example, these recesses 773 may be at least two upwardly opening notches (also numbered 773) in the axial wall 755 defining the cap opening 753. The notches 773 and locking tabs 771 cooperate to orient the cap 85 with respect to the head 51 and to prevent installation of the caps in an orientation other than the proper orientation. The locking tabs 771 are engageable with walls 775 at the lower ends of the notches 773 to limit downward movement of the cap 85 relative to the head 51. Other means for properly orienting the cap 85 relative to the head 51 may be used. For reasons that will appear, the top surface 741 of the cap 85 is spaced below the upper surface of the head 51 when the cap is installed, as shown in FIG. 5.

Each cap 85 is releasably held in assembly with the head 51 by the cap retainer, one version of which is indicated at 93 in FIG. 19. The retainer comprises a part-annular, generally C-shaped retaining member 781 configured for a releasable twist-lock, bayonet connection with the head 51 by means of a number of locking elements 783 (e.g., two locking tabs) projecting laterally from the retaining member, and a corresponding number of generally L-shaped slots, generally indicated 785, in the axial wall 755 of the cap opening 753 in the head. Each such slot 785 has a first axial slot portion 789 extending down from the upper surface of the head 51 and a second circumferential slot portion 791 extending from the first axial slot portion and spaced a distance below the upper surface of the head. The arrangement is such that the locking elements 783 on the retaining member 781 can be pushed down into the axial slot portions 789 and the retaining member then rotated in one direction to move the locking elements into respective second slot portions 791. One or more springs 795 mounted on the retaining member 781 contact the top surface 741 of the cap 85, urging the cap downward and the retaining member upward to maintain the locking elements 783 in their respective circumferential slot portions 791, and thereby locking the retaining member in a cap-retaining position. To release the retainer 93, the retaining member 781 is pushed downward against the bias of the spring(s) 795 and rotated in the opposite direction to remove the locking elements 783 from their respective slots 785. The retainer 93 can then be lifted off of the cap 85 and out of the cap opening 753 in the head 51. A pair of upstanding fingers 797 on the retaining member 781 facilitate manipulation of the retainer 93. Other types of twist-lock connections or releasable couplings for attaching the retainer 93 to the head 51 may be used without departing from the scope of this invention.

Each cap 85 is provided with a suitable number of fastener holes 801 for receiving fasteners (not shown) which thread into the vessel support 99 to secure the cap 85 in place during a reaction process. The upper ends of these holes 801 are recessed below the top surface 741 of the cap 85 so the fastener heads do not project above the caps. (It is also contemplated that the upper ends of the holes may not be recessed below the top surface of the cap.) When the fasteners are tightened, the annular bottom surface 745 of the cap 85 compresses a seal 803 (e.g., an O-ring seal) received in a groove 805 in the top surface 757 of the vessel support 99 to seal the respective reaction chamber 123. Alternately, the seal 803 may be on the underside of the cap 85. The vessel supports 99, vessels 105, and caps 85 are constructed for conducting reactions at pressures different from ambient pressure. In particular, the vessel supports 99, vessels 105, and caps 85 are constructed for conducting reactions at gage pressures from about zero kilopascals (kPa) (zero pounds per square inch (psi)) to about 3400 kPa (500 psi), more specifically, from about 340 kPa (50 psi) to about 2800 kPa (400 psi), even more particularly from about 690 kPa (100 psi) to about 2400 kPa (350 psi), and still more specifically from about 1400 kPa (200 psi) to about 2100 kPa (300 psi).

When the fasteners are removed from the vessel support 99 and fastener holes 801, the retainers 93 hold the caps 85 in position on the head 51. This ensures that any instruments extending down from the cap 85 into the vessel 105, such as the probes discussed below, do not contact the stirrer 133, for example, when the head 51 moves to its raised position. Without the retainers 93 in position, the caps 85 may tilt slightly with respect to the head 51, thereby allowing contact between the instruments and stirrer 133, which should be avoided.

Temperature Control

Another feature of this invention is a temperature control system operable to maintain the vessels 105 at selected temperatures independent of one another, so that reaction mixtures in different vessels may simultaneously be maintained at different precise temperatures during parallel processing. For controlling temperature, each reactor 49 includes a number of temperature control features designed to uniformly control temperatures throughout the reactor. One such feature comprises a temperature control jacket 811 surrounding each vessel support 99 and secured with fasteners 813 for independently controlling the temperature of the reaction mixture in the vessel 105. The control jacket 811 is depicted in FIGS. 4 and 5 as extending substantially the entire length (height as shown) of the vessel support 99. It is contemplated that the jacket 811 may extend less than the full length of the vessel support 99 without departing from the scope of the invention. The jacket 811 may incorporate any suitable heater, such as an electric resistance band heater having a heating capacity of 120 Watts (0.16 horsepower).

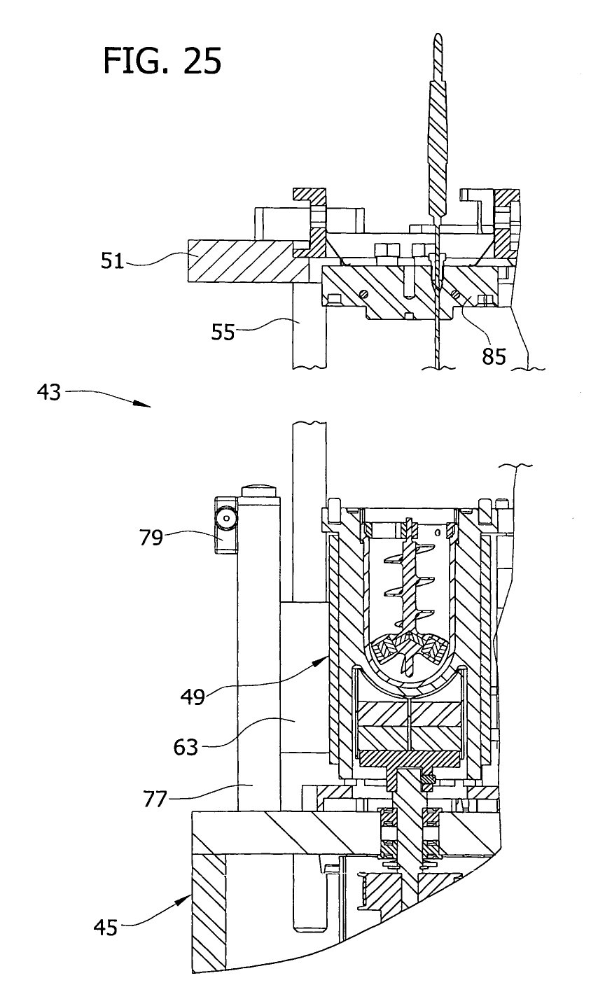

A second temperature control feature comprises at least one additional heater 815 for controlling the temperature of the cap 85 and the headspace above the reaction mixture. Controlling the temperature of the headspace is desirable because it discourages the formation of condensation within the reaction chamber 123. Condensation is undesirable because of its tendency to hold reaction constituents away from the reaction mixture, thereby potentially altering the makeup of the reaction mixture. Heating the headspace above the reaction mixture reduces condensation within the reaction chamber 123 by maintaining the portion of the reaction chamber above !he reaction mixture and the cap 85 at a higher temperature, such that gaseous components are less inclined to collect on the cap and vessel 105 wall portions exposed in the reaction chamber. As best depicted in FIG. 5, one cartridge heater 815 is received within a cavity 819 of each cap 85 to control the temperature of the cap and headspace. The heat output of the heater 815 is controlled to distribute heat throughout the cap 85. More heaters 815 may be added to the cap 85 to further increase the heating capacity of the cap. In one example, two heaters 815 are depicted in FIGS. 4 and 25, and two cavities 819 for receiving heaters are depicted in FIGS. 19, 20, and 26. Other types of heaters 815 suitable for heating the cap 85 and headspace may be utilized without departing from the scope of this invention.

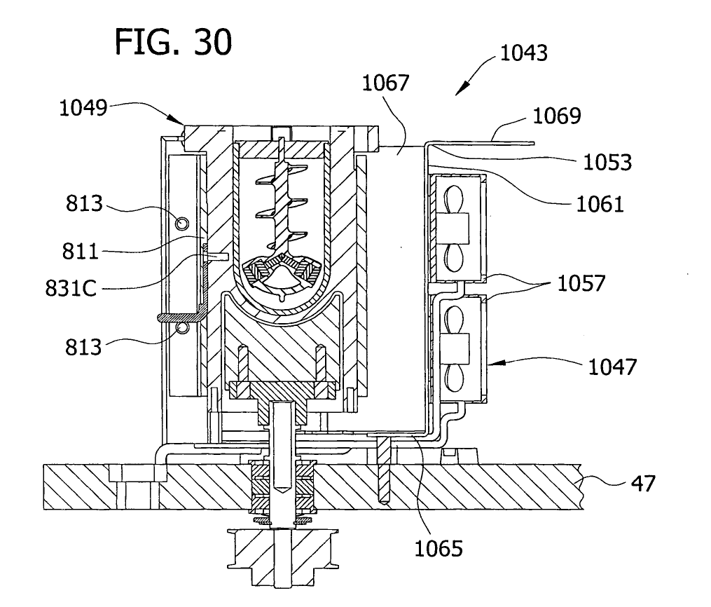

Two temperature probes 831 are associated with each of the reactors 49 for controlling the heat output of the jacket 811 and the cap heater 815 associated with the reactor. One of two temperature probes 831C attaches to the outside of the vessel support 99 and is operable to sense the temperature of the vessel support (FIGS. 4 and 30). The other probe 831B extends through a passage 837 in the cap 85 and preferably contacts the reaction mixture to sense directly the temperature of the reaction mixture (FIG. 5). By monitoring the temperatures of these two probes 831, the apparatus 41 can control the temperature of the reaction mixture and headspace, thereby maintaining the reaction mixture at the appropriate temperature for the given experiment and minimizing the formation of condensation within the reaction chamber 123. In addition, by heating the sides and top of the reactor 49, the temperature within the reactor is uniformly maintained. In one example, the jacket 811 and/or cap heaters 815 may be under the control of a suitable controller, such as a computer, comprising software or hardware for receiving temperature information from at least one of the probes 831 and controlling heat output from the jacket and/or heaters, for controlling the temperature the reaction mixture and/or the headspace.

It should be noted that more, or fewer, temperature probes 831 may be included without departing from the scope of this invention. In one example, an over-temperature probe 831A (FIGS. 2 and 4) may mount on the vessel support 99 to sense when the temperature of the reactor 49 exceeds a threshold temperature, thereby initiating termination of the reaction, as will be discussed in greater detail below.

Monitoring Other Parameters

In addition to monitoring temperature, other parameters of the reaction mixture may also be monitored by passing probes through other passages 841 in the cap 85 to positions in communication with the reaction chamber 123 of each reactor vessel 105 (FIGS. 19 and 20). In one example, a conductivity probe may be used to contact a respective reaction mixture to measure conductivity, and this measurement may be used to determine other reaction conditions (e.g., crystallization, etc.). In addition, or alternatively, an optical probe may be used to measure an optical characteristic (e.g., spectra, reflectance) of a respective reaction mixture, and this measurement may be used to determine other reaction conditions. For any of these probes (temperature probe 831B, conductivity probe, optical probe), a sealing mechanism is disposed within and cooperates with the corresponding passage 837,841 to seal the passage for maintaining the reactor 49 sealed at pressures within the ranges disclosed above.

Fluid Transfer System

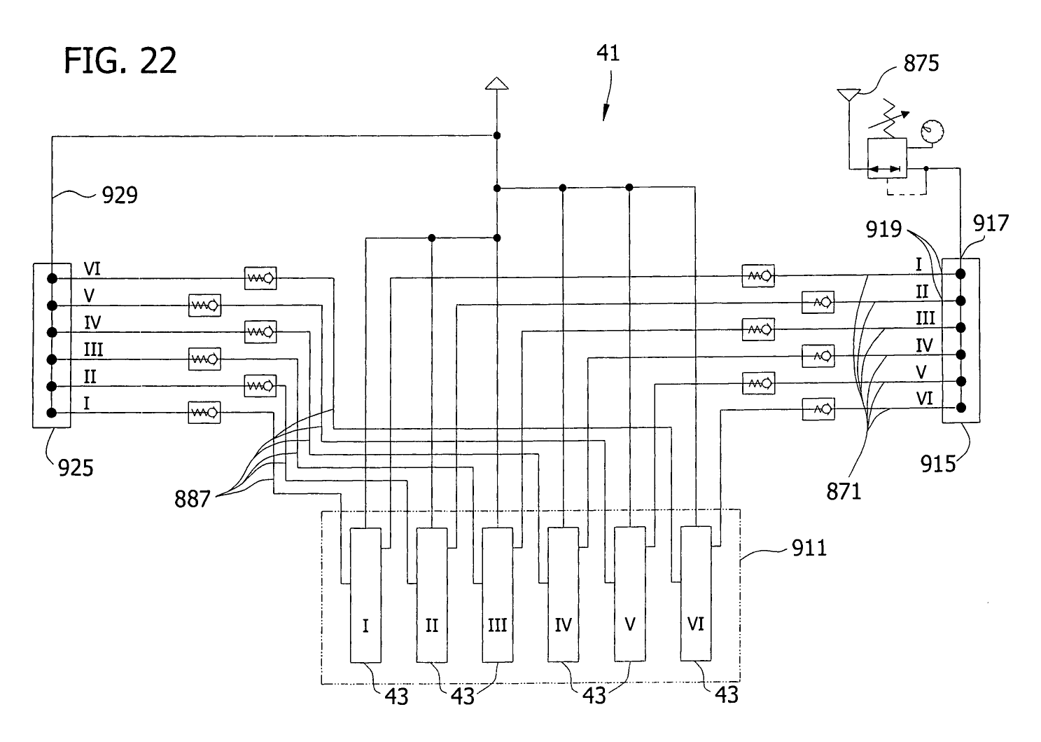

The apparatus 41 further comprises a fluid transfer system for transferring fluids to and from the several vessels 105 while the vessels are at pressures other than ambient pressure. In one embodiment (FIGS. 4 and 22), the fluid transfer system comprises one or more first gas conduits 851, or supply conduits, each in fluid communication with one of the vessels 105 for transferring gaseous components to the vessel, and one or more second gas conduits 853, or vent conduits, each in fluid communication with one of the vessels for transferring gaseous components from the vessels. The gas conduits 851,853 are preferably hard lines capable of withstanding reaction pressures up to 50 MPa (7200 psi), and supply gas pressures that may be as high as 3800 kPa (550 psi). The first and second gas conduits 851,853 include threaded fittings 857 for sealingly and threadably connecting to threaded openings in the vessel support 99 (such as a radial flange 861 at the upper end of the support as depicted in FIG. 4). The threaded openings in the vessel support 99 are oriented to face the outer perimeter of the apparatus 41 for convenience in connecting and disconnecting the fittings 857. The construction and materials of the fittings 857 and gas conduits 851,853 are conventional and will be readily understood by those skilled in the art. In one embodiment (FIG. 23), the supply conduits 851 are connected to a pressurized gas manifold 865 that includes a plurality of inlet gas valves 867 (one valve associated with each supply conduit) for selective opening and closing to allow pressurized gas to flow into particular vessels 105. The pressurized gas manifold 865 connects to a main supply conduit 871 connected to a supply of pressurized gas 875 (FIG. 22) for providing supply gas to the vessels 105.

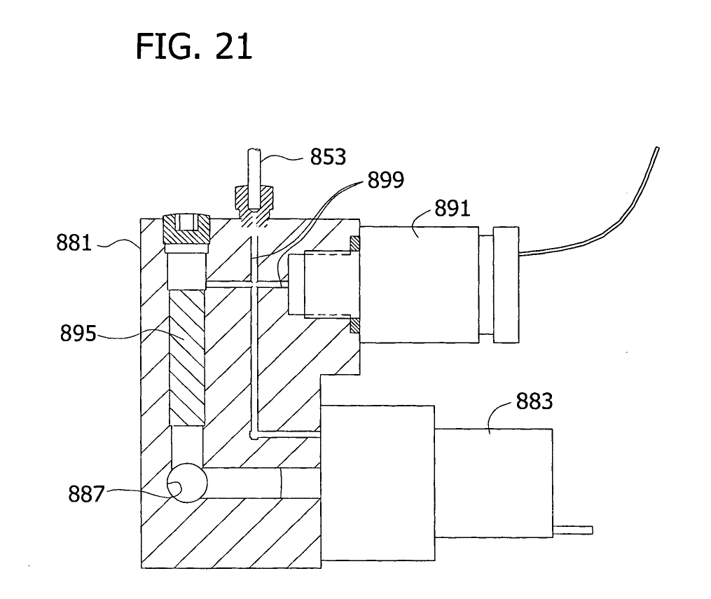

The vent conduits 853 connect to a vent gas manifold 881, which includes a plurality of inlet gas valves 883 for selective opening and closing to allow pressurized gas to vent from particular vessels 105 (FIG. 21). The vent gas manifold 881 connects to a main vent conduit 887 that directs vent gases from all of the vessels 105 from the apparatus 41. In addition, the vent gas manifold 881 includes a plurality of pressure sensors 891 (one sensor associated with each vent conduit 853) in fluid communication with the vent conduits for determining the pressure within the vent conduits, each of which corresponds to the pressure within a corresponding reactor 49. If the pressure within any reactor 49 exceeds a threshold (e.g., 3400 kPa (500 psi)), the corresponding inlet gas valve 883 will open to relieve the pressure. As a backup, the vent gas manifold 881 further comprises a plurality of pressure relief valves 895 (one valve associated with each vent conduit 853) for relieving pressure within a corresponding vent conduit and reactor 49, should the pressure exceed a given threshold (e.g., 4100 kPa (600 psi)). The vent gas manifold 881 includes internal passaging 899 placing each vent conduit 853 in fluid communication with a corresponding pressure sensor 891, inlet gas valve 883, and pressure relief valve 895. It should be understood by one skilled in the art that the pressure relief valves 895 may alternately be located within the supply gas manifold 865, instead of the vent gas manifold 881, or at other flow path locations in communication with the reactors 49, without departing from the scope of the present invention. As depicted in FIG. 21, the inlet gas valves 883 and pressure sensors 891 may be mounted on one surface of the manifold (lateral side as shown) to facilitate access to the valves and sensors.

As will be discussed in greater detail below, the parallel processing apparatus 41 may comprise a number of reactor modules 43 mounted side-by-side on a frame 911 for operation together, each module comprising a plurality of reactors (e.g., eight reactors). Six such reactor modules 43 are shown in FIGS. 22, 30, and 31, yielding a 48 reactor system, but this number may vary. The gas delivery portion of the fluid transfer system for such a reactor system is depicted schematically in the gas flow diagram of FIG. 22. In particular, a supply gas source 875 is in fluid communication with a supply gas distribution manifold 915 having one inlet 917 and multiple outlets 919, each corresponding to a particular reactor module 43 (modules I, II, III, IV, V, and VI as depicted in FIG. 22). Main supply conduits 871, one associated with each reactor module 43, extend from the supply gas distribution manifold 915 to each respective reactor module for fluid communication with each reactor module. The main supply conduits 871 supply gas to the pressurized gas manifold 865 of each reactor module 43, generally as set forth above. Similarly, main vent conduits 887 associated with the reactor modules 43 are in fluid communication with a vent gas collection manifold 925 that collects vent gases from all of the reactor modules. The vent gas collection manifold 925 is in fluid communication with a main vent 929. As such, all 48 reactors 49 may be pressurized via a single supply 875 and vented to a common main vent 929. As will be appreciated by one skilled in the art, one or more additional supply gas sources may be placed in fluid communication with the supply gas distribution manifold 915 using a selector valve (not shown). With such a configuration, the supply gas may be changed during use of the apparatus 41 simply by changing the selector valve.

In one example, the operation of the sensors 891 and the valves 883,895 may be under the control of a suitable controller, such as a computer, comprising software or hardware for receiving pressure information from at least one of the sensors for controlling the operation of the associated valves, which ultimately control the pressure within the associated reactor.

In addition to transfer of gaseous components, the fluid transfer system preferably comprises structure for introduction and withdrawal of fluids to and from the vessels 105 via fluid transfer probe. As discussed above, each of the caps 85 includes passages 841 for communicating with a respective reaction chamber 123. In the embodiment depicted in FIGS. 19 and 20, four of such passages 841 are shown, but this number may vary. (As discussed above, the additional passages 841 may receive other probes to monitor other parameters of the reaction mixture within the reaction chamber 123.) The fluid transfer probe, sometimes referred to as a needle or cannula, is adapted for selective insertion into each such passage 841 for transferring fluids through the passage, after which the probe is removable from the passage. The fluid transfer probe may be inserted and withdrawn manually, or in one example, may be controlled by a conventional three-axis robot system providing translational movement along X, Y, and Z axes. An example of such a conventional three-axis system may be a system commercially available from Tecan Systems, Inc., of San Jose, Calif., Model No. 727633.

In order to maintain the reactor 49 in a sealed condition during insertion into the passage 841 and after withdrawal of the probe from the passage, a sealing mechanism is disposed in the passage to maintain the reactor in a sealed condition. The sealing mechanism receives the fluid transfer probe and maintains the vessel seal as the fluid transfer probe is inserted and withdrawn from the sealing mechanism, thus preventing any substantial pressure losses if the pressure in the reaction vessel 105 is positive, or any pressure gains if the pressure in the reaction vessel is negative with respect to ambient pressure. In one embodiment, the sealing mechanism comprises a valve and a seal, which may be separate elements or formed as a single unit. The valve is movable between a closed position for closing the passage 841 and an open position permitting movement of the probe through the passage. The seal is disposed in the passage and sealingly engages the probe when the valve is in its open position, thereby maintaining pressure within the reaction chamber 123. In one embodiment, the valve is a duckbill valve. An example of such a sealing mechanism is disclosed in U.S. Pat. No. 4,954,149, incorporated herein by reference, owned by Merlin Instrument Company of Half Moon Bay, Calif.

Each of the probe passages 841 is appropriately located on the cap 85 so that the fluid transfer probe, or any other probe, can pass freely into a respective vessel 105 without interference with the bearing 137 and stirrer 133 in the vessel. In this regard, when the vessel 105, bearing 137, stirrer 133, vessel support 99, cap 85, and head 51 are properly assembled, the various registration elements 771,773 described above hold the components in an orientation relative to one another in which a clearance space or volume 935 is maintained with respect to each passage 841 to permit unrestricted passage of the probe through the passage and into the reaction chamber 123. This clearance volume 935 is shown in FIG. 5 as extending from one such passage 837 into the vessel 105. The bearing 137 and stirrer 133 are disposed outside the clearance volume 935 so they will not interfere with the probe 831B. Advantageously, each such clearance volume 935 is maintained substantially constant throughout the course of a reaction without user intervention.

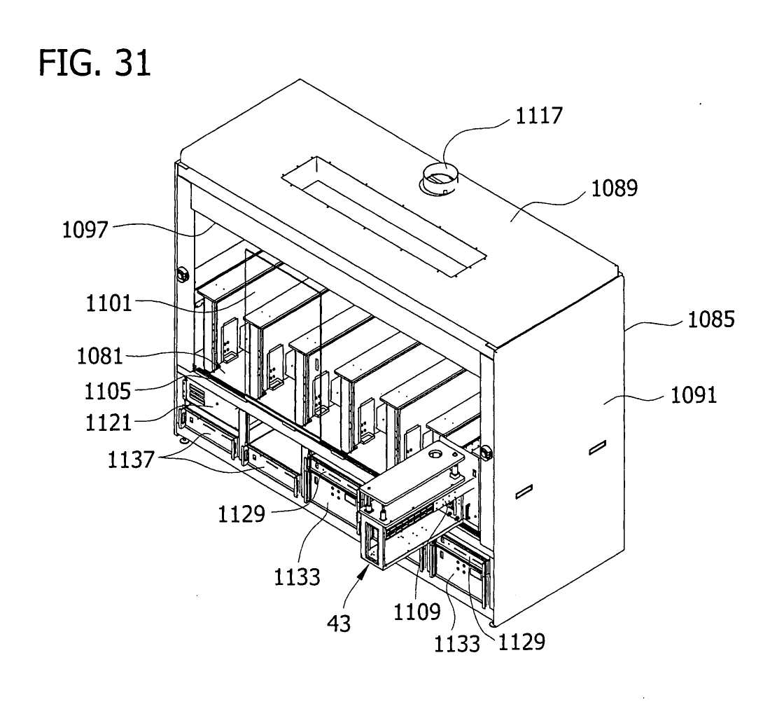

It should be noted that the gas conduits 851,853 and fluid transfer probe may be utilized simultaneously in the same reactor 49. The operation of the robot system, the various valves 867,883 for delivering gases to and from the reactor vessels 105, and other electronic components of the system are under the control of a suitable system processor and software (or firmware), such as a computer, as described below with respect to FIGS. 30 and 31. Reference may also be made to the aforementioned U.S. application Ser. No. 09/548,848, now U.S. Pat. No. 6,455,316, for more detail.

Opening the Reactors

FIGS. 23, 24, and 25 depict the reactor module 43 with the head 51 in a raised position. As discussed above, once the reactions in the reactors 49 are complete, the air cylinder 67 is operable to be pressurized to extend the piston rod 69 for raising the head 51 to a raised position with respect to the vessel platform 47. Once the head 51 is in its raised position, the used assemblies 221 may be removed from the vessel supports 99 and replaced with new assemblies and reaction mixtures. The air cylinder 67 may then be depressurized to retract the piston rod 69 for lowering the head 51 by gravity to a lowered position over the reactors 49, following which the caps 85 are fastened to the vessel supports 99 for sealing the reactors in preparation for further reactions.

Extracting One or More Caps

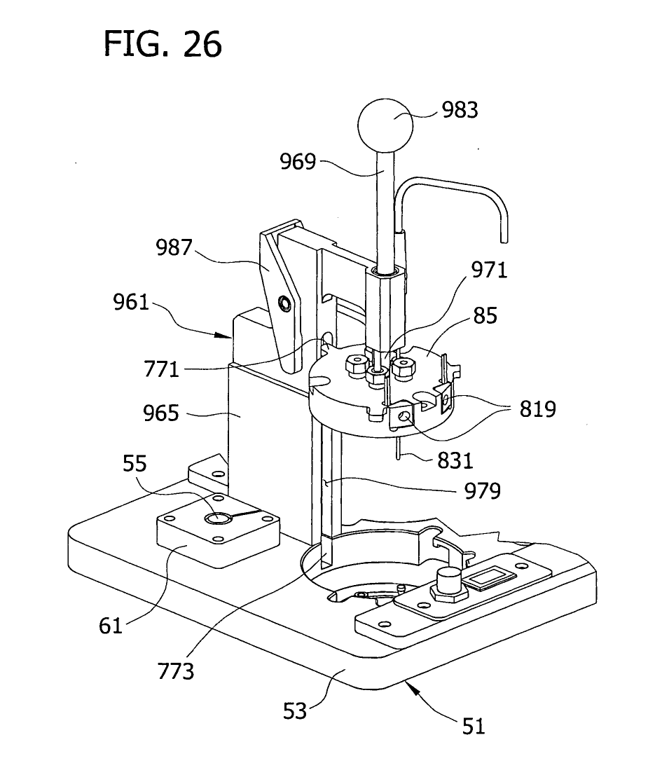

In some situations, it is beneficial to terminate the reaction within a particular reactor or reactors 49 of a reactor module 43, while allowing the reactions in the remaining reactors to continue. In one example, if one reaction is complete, but others are to be continued for some time, it may be efficient and cost-effective to remove the used contents of the completed reaction and restart a new reaction in the same reactor 49. FIG. 26 depicts a reactor cap extractor, generally indicated 961, for use in turning around a reactor 49 under such circumstances. The extractor 961 is useful because the stirrer 133 in the reactor 49 containing the completed reaction will continue to rotate while the other reactions continue, such that removing the cap 85 and various probes 831 must be undertaken with great care to ensure the probes, which may be fragile, and rotating stirrer do not collide with each other. By maintaining the vessel cap 85 and probes 831 in a fixed orientation with respect to the reaction vessel 105, the cap and probes may be raised straight up in a direction parallel to the axis S of the stirrer spindle 155 and removed without incident from the reactor 49 while the stirrer 133 continues to rotate.

In particular, the reactor cap extractor 961 comprises an upstanding framework 965 that may be mounted on the head 51 adjacent a particular reactor 49 for extraction of the cap 85. The framework 965 includes a rod 969 positioned over the center of the cap 85 and slidable in a vertical direction with respect to the reactor 49. The rod 969 has a threaded lower end 971 that threads into an opening 975 on the cap 85 (FIG. 19). The framework 965 additionally includes a vertical channel 979 aligned with one of the upwardly opening notches 773 in the head 51 for receiving one of the locking tabs 771 projecting laterally out from the cap 85 to be removed.

Once the framework 965 is mounted on the head 51, the reactor cap extractor 961 is ready for use. The threaded lower end 971 of the rod 969 is screwed into the threaded opening 975 of the cap 85 to connect the cap to the rod of the extractor 961. The retainer 93 may then be released by pushing the retaining member 781 downward against the bias of the spring(s) 795 and rotating the retainer to remove the locking elements 783 from their respective slots 785. The retainer 93 can then be lifted off of the cap 85 and out of the cap opening 753 in the head 51. The fasteners securing the cap 85 to the vessel support 99 are then removed, so that the cap may be lifted from its corresponding vessel support. A ball 983 mounted on an upper end of the rod 969 is then pulled upward, thereby raising the rod and lifting the cap 85 from the vessel support 99. Because the framework 965 maintains the rod 969 in a vertical position, the probes 831 extending down from the cap 85 move upward along a linear vertical path, thereby maintaining an appropriate clearance with respect to the rotating stirrer 133. As the cap 85 is raised, the locking tab 771 of the cap 85 aligned with the vertical channel 979 in the framework 965 of the extractor 961 slides freely up through the channel until it passes a spring-biased catch 987, which holds the cap in a fully raised position until released by the user. Thus, the extractor 961 maintains the orientation of the cap 85 and probe(s) 831 relative to the stirrer 133, thereby eliminating the possibility of interference as the cap is removed. Once the cap 85 is lifted, the used vessel/bearing/stirrer assembly 221 in the reactor 49 may be removed by an assembly removal tool (not shown) using removal holes 991 located toward an upper end of the vessel 105 (FIG. 8). To enhance clearance between the vessel support 99 and the extractor 961, cap 85, and probe(s) 831, the extractor may be removed from the head 51 during removal of the used assembly 221 and insertion of the new assembly within the vessel support. The extractor 961 may then be reinstalled on the head 51, after which the catch 987 is released and the cap 85 lowers to its position on the vessel support 99 for securement by the fasteners.

In an effort to reduce spillage during such a reactor changeover, a drip funnel, generally indicated 995, may be seated on the vessel support 99 in place of the cap 85 to collect and direct any liquid material dripping from the caps and/or probe 831 into the well 111 of the vessel support. A mouth 997 of the drip funnel 995 is wider than the cap opening 753 to inhibit drips from falling onto portions of the head 51 adjacent the opening or between the vessel support 99 and the cap opening. To secure the funnel 995 in place, a bottom surface 999 of the funnel includes keyways 1003 which mate with keys 763 in keyways 765 in the top surface 757 of the vessel support 99. As discussed above with respect to the cap 85, the number of keys 763 (or other alignment devices) used may vary. Once the funnel 995 is installed, the used assembly 221 may be removed from the vessel support 99 and any liquid dripping from the assembly or the cap 85 held by the extractor 961 will be caught by the drip funnel and directed toward the open well 111 of the vessel support, rather than falling upon the head 51 of the reactor module 43.

FIGS. 29 and 30 depict a second embodiment of a reactor module, generally indicated 1043, of this invention. The second embodiment is similar to the first embodiment, except for the addition of a cooling assembly, generally indicated 1047, adjacent each reactor, generally indicated 1049. Each cooling assembly 1047 comprises a shroud 1053 mounting two cooling fans 1057 for cooling a respective reactor 1049. In the illustrated embodiment, each shroud 1053 comprises a fan wall 1061 adjacent the reactor 1049 for mounting a number of fans 1057 (e.g., two fans) in a position in which the fans direct air through openings in the wall (FIG. 30). The shroud 1053 also includes a bottom wall 1065 underlying the reactor 1049, a pair of side walls 1067 extending from the fan wall 1061 on opposite sides of the reactor, and a top wall 1069 extending from the fan wall over the fans 1057 for safety. The shroud 1053 may be a unitary structure formed of sheet metal or other suitable material. The cooling fans 1057 blow air through the openings and against the reactor 1049 for cooling it. Alternatively, the fans 1057 could turn in the opposite direction and draw cooling air past the reactor 1049. The side walls 1067 of the shroud 1053 extend past the reactor 1049 to guide cooling air about the reactor. As depicted in FIG. 29, the side walls 1067 also isolate the cooling air to a particular reactor 1049, thereby limiting the cooling air from flowing against an adjacent reactor. In this manner, the cooling assembly 1047 can readily cool a single reactor 1049 without substantially affecting the temperature of adjacent reactors. More or fewer cooling fans 1057 may be mounted adjacent the reactor 1049 without departing from the scope of the present invention.

As discussed above with respect to the reactor cap extractor 961, it may be desirable to remove and replace a particular reactor 49,1049 while the other reactors continue under reaction conditions. In this situation, it is important to lower the temperature of the reactor 49,1049 to near ambient before extracting the cap 85 and removing the assembly 221. The cooling fans 1057 associated with each reactor 49,1049 may be selectively activated to cool a particular reactor while the other reactors are maintained at higher temperatures, thereby facilitating the cooling process and leading to a further reduced turn-around time of the individual reactor. Moreover, the cooling assemblies 1047 may be activated together when it is desirable to cool all the reactors 49,1049 of the reactor module 43,1043, such as during a turn-around of the entire reactor module. In one example, the operation of the cooling fans 1057 may be under the control of a suitable controller, such as a computer, comprising software or hardware for receiving temperature, pressure, user input, or other information for controlling the operation of the cooling fans or fan, which ultimately controls the cooling the associated reactors or reactor, respectively.

Operation of the Apparatus

The general operation of the apparatus 41 will now be described. In use, the head 51 is initially raised to allow access to the reactors 49. If reactions have been performed, the used assemblies 221, each comprising a vessel 105, a bearing 137, a stirrer 133, and a reaction mixture, are removed from the vessel supports 99 using a suitable tool and the holes 991 in the wall of the reactor vessel near its upper end (FIG. 8). Once the used assemblies 221 are removed from the vessel supports 99, new replacement assemblies may be inserted for further reactions. These assemblies 221 may include starting materials pre-loaded into the vessels 105. With the head 51 is the raised position, the cap retainers 93 hold the caps 85 in position on the raised head, thereby maintaining the orientation of the caps and any probes 831 depending therefrom for reception by the reactors 49.

Once the new assemblies 22i are received in the vessel supports 99, the head 51 is lowered into position over the reactors 49 of the vessel platform 47 by depressurizing the linear actuator 57. The two stops 77 on the vessel platform 47 limit downward movement of the head 51 so that it remains spaced above the vessel platform in its lowered position. The microswitch 79 mounted on an upper end of one of these stops 77 provides a signal to the apparatus 41 to allow for heating of the vessels when the head 51 reaches its lowered position. In this position, the head 51 does not contact the vessel supports 99, thereby thermally isolating the vessel supports from the head.

After the caps 85 are placed on respective vessel supports 99, fasteners are used to secure each cap to a corresponding vessel support. With the fasteners tightened, the annular bottom surface 745 of the cap 85 compresses the seal 803 to seal the respective reaction chamber 123. Once sealed, the reactions may occur generally as set forth above, and as similarly described in the parallel reactor system described in the aforementioned publications and applications, including U.S. application Ser. No. 09/548,848, filed Apr. 13, 2000, now U.S. Pat. No. 6,455,316, issued Sep. 24, 2002.

When the reactions are complete, or after termination of one or more reactions with a quench gas delivered via the supply conduits 851, any non-ambient pressure within the reaction chambers may be relieved via the vent conduits 853 by opening the gas valves 883 of the vent gas manifold 881. Moreover, the drive mechanism 141 and the heating devices 811,815 may be deactivated to stop heating and stirring the reaction mixtures, while the cooling fans 1057 may be activated to collectively cool the reactors 49. With the reactions complete and the reactors 49 cooled and depressurized, the fasteners securing the caps 85 to the vessel supports 99 are removed. The air cylinder 67 is then activated to raise the head 51 to its raised position, after which the used assemblies 221 are removed and replaced with new assemblies containing new reaction mixtures. The head 51 is then lowered to position the caps 85 on the vessel supports 99. After the caps 85 have been fastened to respective vessel supports 99, a new set of reactions may begin.

As noted above in describing the reactors 49 of the present invention, the embodiments described above describe multiple reactors, but it should be understood that the apparatus 41 of the present invention may include only one reactor having a single vessel 105 containing a single reaction mixture.

Multiple Reactor Modules

The parallel processing apparatus 41 comprises a number of reactor modules 43, each having a plurality of reactors 49 (e.g., eight reactors), mounted side-by-side on a framework 1081. A framework capable of supporting six such reactor modules 43 is shown in FIGS. 30 and 31, yielding a 48 reactor system, but the number of reactor modules may vary from one to six or more. Further, a parallel processing apparatus of the invention need not be modular, but rather it could be a single monolithic reactor having multiple reaction vessels therein. The apparatus is preferably a research reactor, but could also be a relatively small-volume production reactor.

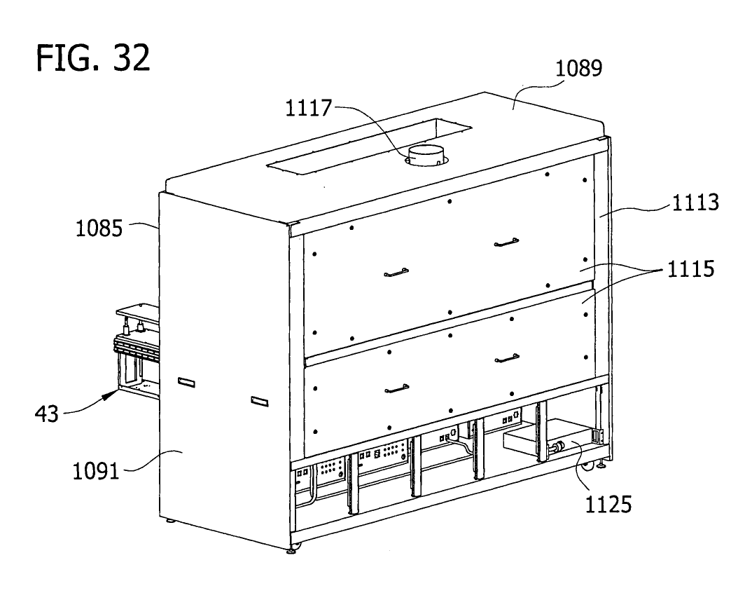

In one example, depicted in FIGS. 30 and 31, much of the apparatus 41 and its components, discussed above, are enclosed by an enclosure, such as a cabinet 1085. The cabinet includes the framework 1081 for supporting the apparatus 41, and top 1089, side 1091, and bottom walls for enclosing the apparatus 41. An opening 1097 extending across the front of the cabinet 1085 includes movable doors 1101 for selectively enclosing the apparatus 41 within the enclosure. The doors 1101 are typically transparent, so that the apparatus 41 may be viewed while the doors are shut. The doors 1101 slide on rails 1105 along the front of the cabinet 1085, thereby providing access to the interior of the cabinet and the apparatus 41. Providing additional access to the apparatus 41, each reactor module 43 is slidable on one or more drawer slides 1109 oriented parallel to the sides 1091 of the cabinet 1085 for sliding movement of each reactor module through the front opening 1097 of the cabinet. This sliding movement provides improved access to the reactor modules 43, allowing unrestricted access to the length of each reactor module, and thereby each reactor 49. A rear wall 1113 of the framework 1081 (FIG. 32) desirably includes removable access panels 1115 for accessing the apparatus 41 from the rear. The cabinet 1085 may further include a vent 1117 for removing air from within the cabinet and lights for illuminating the interior of the cabinet. A user interface (not shown), such as a computer display and a data input device (e.g., keyboard and mouse) are positioned outside the cabinet 1085, but are connected to the apparatus 41, via a computer 1121, for control of the apparatus within the cabinet.

The cabinet 1085 additionally houses several other components of the apparatus 41, including the computer 1121 under control of the data input device for controlling the operations of the apparatus, a power distribution unit 1125 for distributing power to the components of the apparatus, over-temperature controllers 1129 connected to the over-temperature probe 831 A for determining when a particular reactor 49 passes the over-temperature threshold, heater controllers 1133 for controlling the operation of the heaters 811,815,and fan control modules 1137 for controlling the operation of the fans 1057. In one example, combining three over-temperature controllers 1129, each having 16 zones, allows for over-temperature control of 48 zones, corresponding to one over-temperature probe 831A per reactor 49 of a 48 reactor apparatus. An exemplary over-temperature controller 1129 is the Watlow 2×8 Zone controller, available from Watlow Electric Manufacturing Company of St. Louis, Mo., U.S.A. In another example, combining three heater controllers 1133, each having 32 zones, allows for control of 96 zones, corresponding to two heaters 811,815 per reactor 49 of a 48 reactor apparatus. An exemplary heater controller 1133 is the Watlow MLS332 controller, available from Watlow Electric Manufacturing Company of St. Louis, Mo., U.S.A. In yet another example, combining three fan control modules 1137, each having 16 channels, allows for control of 48 channels, corresponding to two cooling fans 1057 per reactor 49 of a 48 reactor apparatus (fan pairs are energized together). An exemplary fan control module is the Opto 22 sixteen channel relay board, available from Opto 22 of Temecula, Calif., U.S.A. The cabinet 1085 additionally includes at least one emergency off switch 1141 for terminating power to the apparatus 41, except for the computer, the vent 1117, and the dry box (discussed below). Further details of the foregoing components will not be discussed here, as they will be readily understood by those skilled in the art.

In another example, much of the apparatus 41 and its components discussed above are enclosed by an enclosure (not shown). The enclosure is preferably what is referred to as a “dry box” or a “glove box” having gloves affixed to the periphery of openings in the side walls of the enclosure to allow an operator to manipulate items inside the enclosure and reduce possible contamination. The enclosure can be gas-tight and/or filled with a pressurized inert gas (e.g., argon or nitrogen). In either case, the environment is controlled to eliminate contaminants or other material which might interfere with the parallel reaction processes being conducted in the enclosure. Conventional antechambers (air locks) on the enclosure provide access to the interior of the enclosure. Glove box enclosures suitable for use in the present invention are available from, among others, Vacuum Atmospheres Company of Hawthorne, Calif., and M. Braun Inc. of Newburyport, Mass., U.S.A. Other types of enclosures may also be used, such as a purge box which is movable between a non-enclosing position and an enclosing position and purged of contaminants using a pressurized inert gas.

As described in detail herein and as would be readily understood by one skilled in the art, the following features are contemplated as within the scope of the present invention. In one example, an apparatus for processing of a reaction mixture comprises a spindle including an upper end rotatable in an opening of a bearing hub. In another example, a bearing comprises at least two resilient arms adapted to flex upon placement of the bearing in a vessel. In yet another example, a vessel support and a cap are keyed with respect to one another for orienting the cap with respect to the vessel support. In still another example, a bearing having at least two arms includes support members on the at least two arms for engaging an upper rim of a vessel for locating the bearing in a generally axial direction with respect to the vessel. In a further example, a vessel and a vessel support are keyed with respect to one another for orienting the vessel with respect to the vessel support.

In still another example, a pressurized gas manifold comprises a plurality of pressure relief valves, one valve associated with each of a plurality of first gas conduits, for relieving pressure within a corresponding first gas conduit and reaction chamber, should the pressure exceed a threshold. In a further example, a sealing mechanism cooperates with at least one passage in a cap for maintaining a vessel seal.

In another example, a cap includes at least one heater comprising a cartridge heater received within a cavity of the cap. In a further example, vessels for holding reaction mixtures are each associated with a temperature control jacket operable to control the temperature of the reaction mixture within a respective vessel, and a controller operates the temperature control jackets to control the temperatures of the reaction mixtures in the vessels independent of one another. In another example, a temperature control jacket comprises an electric resistance band heater. In yet another example, an apparatus comprises at least two temperature probes associated with a vessel, whereby one of the at least two temperature probes is operable to sense the temperature of a vessel support, and another of the at least two temperature probes is operable to sense the temperature of the reaction mixture. In still another example, an apparatus includes a cooling assembly comprising at least two cooling fans for blowing cooling air toward a temperature control jacket and a vessel support. The cooling assembly may further comprise a shroud for directing the cooling air toward the temperature control jacket and vessel support.

The apparatus may further comprise other vessels for holding reaction mixtures, other vessel supports adapted for supporting respective other vessels, other temperature control jackets operable to control the temperatures of the reaction mixtures within the respective other vessels, other cooling fans for blowing cooling air toward the other temperature control jackets and the other vessel supports, and other shrouds for directing cooling air toward the other temperature control jackets and the other vessel supports. Each of the shrouds may direct cooling air toward a respective temperature control jacket and vessel support and away from other temperature control jackets and vessel supports. The apparatus may further comprise a controller for controlling the operation of the at least two cooling fans.

In another example, an apparatus comprises a conductivity probe received within at least one passage of a cap for contacting a reaction mixture. The apparatus may also comprise a temperature probe received within at least one passage of the cap for contacting the reaction mixture. The apparatus may also comprise an optical probe received within at least one passage of the cap for measuring a characteristic of the reaction mixture. The apparatus may also comprise a sealing mechanism cooperating with the at least one passage for maintaining a vessel seal.

In another example, the apparatus comprises a vessel having a total volume of between about 10 ml (0.34 oz) and about 80 ml (2.7 oz). The vessel may further have a total volume of between about 10 ml (0.34 oz) and about 50 ml (1.7 oz). The vessel may further have a total volume of between about 12 ml (0.41 oz) and about 40 ml (1.4 oz).

In another example, the apparatus comprises a vessel support, a vessel, and a cap constructed for conducting reactions at gage pressures from about zero kilopascals (kPa) (zero pounds per square inch (psi)) to about 3400 kPa (500 psi). The vessel support, vessel, and cap may be further constructed for conducting reactions at gage pressures from about 340 kPa (50 psi) to about 2800 kPa (400 psi). The vessel support, vessel, and cap may be further constructed for conducting reactions at gage pressures from about 690 kPa (100 psi) to about 2400 kPa (350 psi). The vessel support, vessel, and cap may be further constructed for conducting reactions at gage pressures from about 1400 kPa (200 psi) to about 2100 kPa (300 psi).

In still another example, an apparatus may comprise a vessel having an aspect ratio (L/D) of less than about 4. The vessel may also have an aspect ratio (L/D) of less than about 3. The vessel may also have an aspect ratio (L/D) of less than about 2.

In yet another example, an apparatus comprises a stirrer comprising a first magnetic follower comprising at least two permanent magnets and a second magnetic follower comprising at least two permanent magnets. In another example, the permanent magnets are sealed within a stirring implement. In still another example, an apparatus includes a stirrer comprising flux guide constructed of ferromagnetic material. The flux guide may be constructed of steel. In yet another example, the stirrer may be constructed of a material with a lower magnetic flux permeability than the flux guide. In one example, the stirrer is constructed of stainless steel. In still another example, the stirrer is capable of operation at temperatures from about 0° C. (30° F.) to about 350° C. (660° F.). The stirrer may also be capable of operation at temperatures from about 20° C. (68° F.) to about 200° C. (390° F.). The stirrer may also be capable of operation at temperatures from about 40° C. (100° F.) to about 160° C. (320° F.). In yet another example, the apparatus comprises a magnetic driver configured to rotate a stirrer at speeds from about 0 rpm to about 2000 rpm. The magnetic driver may also be configured to rotate the stirrer at speeds from about 100 rpm to about 1000 rpm. The magnetic driver may further be configured to rotate the stirrer at speeds from about 100 rpm to about 500 rpm.

In another example, an apparatus comprises a bearing received by a vessel within a reaction chamber; a spindle being rotatable in the bearing. In a further example, an apparatus includes a stirrer comprising a magnetic stir bar.

In another example, a stirring system for use in a reactor includes a stirrer comprising first and second magnetic followers, each follower having a magnetic pole axis. An included angle between the magnetic pole axis of the first magnetic follower and the magnetic pole axis of the second magnetic follower is one of less than and equal to about 2.6 radians (150 degrees). The included angle between the magnetic pole axis of the first magnetic follower and the magnetic pole axis of the second magnetic follower may also be one of less than and equal to about 2.1 radians (120 degrees). In another example, the system comprises a magnetic driver framework constructed of a material having a low magnetic flux permeability. The driver framework may be constructed of aluminum. In still another example, a rotatable magnetic driver comprises a first magnetic driver element comprising at least two permanent magnets and a second magnetic driver element comprising at least two permanent magnets. The first and second magnetic driver elements may comprise magnets constructed of at least one of Samarium Cobalt 28 Grade 28, Samarium Cobalt Grade 18, and Samarium Cobalt Grade 20 magnetic materials. In yet another example, a first flux guide is positioned in a driver framework above a first magnetic driver element and a second flux guide is positioned in the driver framework above a second magnetic driver element. The driver framework may further include a first cavity for receiving the first flux guide and a second cavity for receiving the second flux guide. The first cavity and the first flux guide may be keyed with respect to one another for orienting the first flux guide with respect to the driver framework; and the second cavity and the second flux guide are keyed with respect to one another for orienting the second flux guide with respect to the driver framework. In another example, the system comprises flux guides having first and second concave surfaces shaped and sized relative to a bottom surface of a vessel for providing substantially uniform spacing between the concave surfaces and the bottom of the vessel that may range from about 1 mm (0.04 in) to about 10 mm (0.4 in). The spacing may further range from about 2 mm (0.08 in) to about 5 mm (0.2 in). In another example, a vessel has a convex bottom surface facing a flux guide comprising first and second concave surfaces. The concave surfaces may further be spaced a substantially uniform distance from the convex bottom surface of the vessel. In another example, a rotatable magnetic driver comprises first and second flux guides constructed of a ferromagnetic material. The first and second flux guides may be constructed of steel.

In yet another example, the system includes a drive mechanism comprising a drive train comprising a belt and pulley system coupled to drive shafts adapted to couple with respective magnetic drivers. A motor may drive the belt and pulley system to rotate the drive shafts. The drive mechanism may further comprise a gearbox coupled to the motor and to the belt and pulley system for driving the belt and pulley system at a speed different than the speed of the motor. The system may further comprise a controller for controlling the operation of the motor.

In still another example, a stirrer comprises first and second magnetic followers having magnetic pole axes, whereby an included angle between the magnetic pole axis of the first magnetic follower and the magnetic pole axis of the second magnetic follower is one of less than and equal to about 3.1 radians (180 degrees). The included angle may also be one of less than and equal to about 2.6 radians (150 degrees). The included angle may also be one of less than and equal to about 2.1 radians (120 degrees). In another example, a stirrer comprises at least two permanent magnets enclosed by a stirring implement, and wherein a flux guide comprises at least one flux guide element in a passage in the stirrer extending between the permanent magnets. In yet another example, a stirrer comprises at least one stirring element having an inner end adjacent a spindle and an outer end opposite the inner end, wherein the inner end has a smaller cross section than the outer end. In another example, a stirrer comprises at least one stirring element having a substantially airfoil-shaped cross section. The stirrer may also comprise stirring elements creating low shear forces within a reaction mixture in a vessel. In still another example, a stirrer comprises a paddle extending substantially perpendicular to a plane containing stirring elements. The paddle may also comprise at least two substantially planar blades projecting laterally from a spindle in a respective plane. The respective blades may be oriented askew relative a longitudinal axis of the spindle. In another example, a stirrer comprises four mixing arms arranged about every 1.6 radians (90 degrees) around a hub. In still another example, a stirrer comprises a first mixing arm oriented in a first lateral direction enclosing one of at least two permanent magnets and a second mixing arm oriented in a second lateral direction generally opposite the first lateral direction enclosing another of the at least two permanent magnets. In yet another example, a stirrer comprises a spindle and a stirring implement constructed of at least one of a chemically-resistant plastic material and stainless steel. The chemically-resistant plastic material may be at least one of a perfluoro-elastomer, a polyethylethylketone, and a polytetrafluoroethylene.

In another example, an apparatus for processing of reaction mixtures comprises a cap and a head, each having cooperating registration elements for orienting the cap relative to the head wherein said cooperating registration elements include at least two registration elements on the cap and corresponding recesses in the head for receiving the at least two registration elements. In still another example, an apparatus comprises a cap retainer having a twist-lock connection with a head. The twist-lock connection may also comprise a bayonet connection. In yet another example, the apparatus includes an extractor comprising a rod positioned over a cap and attachable to the cap for lifting the cap.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

1. Apparatus for processing of a reaction mixture, comprising:
a vessel for holding a reaction mixture for processing;
a vessel support adapted for supporting the vessel;
a cap sealingly engaging the vessel support for sealing the vessel within said vessel support;
said vessel, vessel support, and cap defining a reaction chamber;
a bearing within the reaction chamber;
a stirrer rotatable in the reaction chamber;
said stirrer comprising a spindle rotatable in said bearing;
said stirrer further comprising at least one stirring implement extending from the spindle for contacting the reaction mixture;
said stirrer further comprising at least one magnet on said stirrer;
said at least one magnet being adapted to be subjected to a rotating magnetic field in the vessel for causing said stirrer to rotate thereby to mix the reaction mixture.

2. The apparatus as set forth in claim 1 wherein said bearing comprises a hub and an opening in the hub for receiving said rotatable spindle.

3. The apparatus as set forth in claim 2 wherein said bearing comprises at least two arms extending outward from said hub for engagement with the vessel to support the bearing within the vessel.

4. The apparatus as set forth in claim 3 wherein said vessel includes at least two recesses, and
wherein the at least two arms of the bearing include registration members adapted to be received in respective said at least two recesses of the vessel for locating the bearing within the vessel in a generally circumferential direction.

5. The apparatus as set forth in claim 1 wherein said vessel has at least one hole configured for receiving a tool to permit removal of said vessel from the vessel support.

6. The apparatus as set forth in claim 1 further comprising a fluid transfer system for transferring fluids to or from the vessel while the vessel is at a pressure other than ambient pressure.

7. The apparatus as set forth in claim 6 wherein said fluid transfer system comprises a first gas conduit in fluid communication with said vessel for transferring gaseous components to said vessel.

8. The apparatus as set forth in claim 7 wherein said fluid transfer system further comprises a second gas conduit in fluid communication with said vessel for transferring gaseous components from said vessel.

9. The apparatus as set forth in claim 8 further comprising other vessels for holding reaction mixtures, other first gas conduits in fluid communication with respective said other vessels for transferring gaseous components thereto, and other second gas conduits in fluid communication with respective said other vessels for transferring gaseous components therefrom, said vessels being grouped together to form a reactor.

10. The apparatus as set forth in claim 9 further comprising a pressurized gas manifold connected to said first gas conduits and a supply conduit connected to said pressurized gas manifold, said supply conduit providing gaseous components to said pressurized gas manifold and said vessels.

11. The apparatus as set forth in claim 10 wherein said pressurized gas manifold further comprises a plurality of first gas valves associated with said first gas conduits for selective opening and closing to allow pressurized gas to flow into particular vessels.

12. The apparatus as set forth in claim 11 further comprising a controller for controlling the operation of said plurality of first gas valves.

13. The apparatus as set forth in claim 9 further comprising a vent gas manifold connected to said second gas conduits and a vent conduit connected to said vent gas manifold, said vent conduit directing vent gases from said vent gas manifold.

14. The apparatus as set forth in claim 13 wherein said vent gas manifold further comprises a plurality of second gas valves associated with said second gas conduits for selective opening and closing to allow pressurized gas to vent from particular vessels.

15. The apparatus as set forth in claim 14 wherein said vent gas manifold further comprises a plurality of pressure sensors, one sensor associated with each of said plurality of second gas conduits, for determining the pressures within the second gas conduits, which correspond to the pressures within corresponding vessels.

16. The apparatus as set forth in claim 14 further comprising a controller for controlling the operation of said plurality of second gas valves.

17. The apparatus as set forth in claim 6 wherein said cap includes at least one passage for communicating with a respective reaction chamber.

18. The apparatus as set forth in claim 17 wherein said fluid transfer system further comprises a fluid transfer probe adapted for insertion and withdrawal from said passage for transferring fluids through said passage.

19. The apparatus as set forth in claim 17 further comprising at least one clearance volume extending into said vessel from said at least one passage for receiving an object inserted through said passage,
said cap and bearing being adapted for orientation with respect to one another such that said bearing remains outside of said clearance volume.

20. The apparatus as set forth in claim 1 further comprising at least one heater associated with the vessel for controlling the headspace temperature above the reaction mixture.

21. The apparatus as set forth in claim 20 wherein said cap includes said at least one heater for controlling the temperature of the cap and the headspace.

22. The apparatus as set forth in claim 20 further comprising a temperature control jacket associated with said vessel and operable to control the temperature of the reaction mixture in the vessel.

23. The apparatus as set forth in claim 22 further comprising a cooling assembly associated with the temperature control jacket and vessel support for cooling the temperature control jacket and vessel support.

24. The apparatus as set forth in claim 20 further comprising a controller for controlling the operation of said at least one heater.

25. The apparatus as set forth in claim 1 wherein said cap further comprises at least one passage through said cap in communication with the reaction chamber.

26. The apparatus as set forth in claim 1 wherein said vessel support, vessel, and cap are constructed for conducting reactions at pressures different than ambient pressure.

27. Apparatus for processing of a reaction mixture, comprising:
a vessel adapted for holding a reaction mixture for processing; and
a stirring system for stirring the reaction mixture in the vessel, said stirring system comprising,
a stirrer contained in said vessel, and
a drive mechanism comprising a magnetic driver coupled to the stirrer for rotating the stirrer within the vessel;
the stirrer comprising
a first magnetic follower,
a second magnetic follower, and
a flux guide for guiding magnetic flux between the first magnetic follower and the second magnetic follower.

28. The apparatus as set forth in claim 27 wherein said magnetic driver is operable to generate a rotating magnetic field in the vessel,
said followers of the stirrer in the vessel being rotatable in response to said rotating magnetic field to rotate the stirrer to stir the reaction mixture.

29. The apparatus as set forth in claim 28 wherein said first magnetic follower comprises at least one permanent magnet, and
wherein said second magnetic follower comprises at least one permanent magnet.

30. The apparatus as set forth in claim 27 further comprising other vessels for holding reaction mixtures,
said apparatus further comprising a temperature control system operable to maintain the vessels at selected temperatures independent of one another whereby different vessels may simultaneously be maintained at different temperatures.

31. The apparatus as set forth in claim 27 further comprising other vessels for holding reaction mixtures, and
a controller for parallel processing of the reaction mixtures in said vessels.

32. The apparatus as set forth in claim 27 further comprising other vessels for holding reaction mixtures, wherein said other vessels are sealed against fluid communication with one another.

33. The apparatus as set forth in claim 27 further comprising a vessel support adapted for supporting the vessel and a cap sealingly engaging the vessel support for sealing the vessel within said vessel support,
said vessel, vessel support, and cap defining a reaction chamber.

34. A stirring system for use in a reactor, said system comprising:
a vessel for holding a reaction mixture for processing;
a stirrer received in the vessel, said stirrer comprising
a spindle including an upper end,
a lower end, and
at least two stirring elements adjacent the lower end;
a first magnetic follower sealed inside one of said at least two stirring elements, and
a second magnetic follower sealed inside another of said at least two stirring elements,
wherein the magnetic pole axis of the first magnetic follower and the magnetic pole axis of the second magnetic follower are not parallel; and
a drive mechanism for generating a rotating magnetic field in the vessel to rotate the stirrer and thereby mix the reaction mixture.

35. The system as set forth in claim 34 wherein an included angle between the magnetic pole axis of the first magnetic follower and the magnetic pole axis of the second magnetic follower is one of less than and equal to about 3.1 radians (180 degrees).

36. The system as set forth in claim 34 wherein said drive mechanism comprises a rotatable magnetic driver associated with the vessel to generate said rotating magnetic field in the vessel.

37. The system as set forth in claim 36 wherein the rotatable magnetic driver comprises
at least one permanent magnet and
at least one flux guide for guiding magnetic flux between said at least one permanent magnet and said stirrer.

38. The system as set forth in claim 37 wherein said rotatable magnetic driver comprises a driver framework for positioning the at least one flux guide with respect to the at least one permanent magnet.

39. The system as set forth in claim 38 wherein said rotatable magnetic driver comprises
a first magnetic driver element comprising a north-seeking pole and a south-seeking pole,
said first magnetic follower comprising a north-seeking pole and a south-seeking pole,
one of said north-seeking pole and said south-seeking pole of said first magnetic driver element being oriented substantially toward an oppositely seeking pole of said first magnetic follower,
said magnetic driver further comprising a second magnetic driver element comprising a north-seeking pole and a south-seeking pole,
said second magnetic follower comprising a north-seeking pole and a south-seeking pole,
one of said north-seeking pole and said south-seeking pole of said second magnetic driver element being oriented substantially toward an oppositely seeking pole of said second magnetic follower,
such that said first and second magnetic driver elements create a magnetic field and rotation of said magnetic driver generates said rotating magnetic field.

40. The system as set forth in claim 39 wherein said at least one flux guide comprises
a first flux guide for guiding flux between said first magnetic driver element and said first magnetic follower and
a second flux guide for guiding flux between said second magnetic driver element and said second magnetic follower.

41. The system as set forth in claim 40 wherein said first flux guide includes a first concave surface facing said vessel and said second flux guide includes a second concave facing said vessel.

42. The system as set forth in claim 41 wherein said first and second concave surfaces are shaped and sized relative to a bottom surface of the vessel such that as the magnetic driver rotates, the concave surfaces maintain a substantially uniform spacing from the bottom surface of the vessel.

43. The system as set forth in claim 36 wherein said drive mechanism further comprises a drive shaft adapted to couple with the magnetic driver for driving rotation of said magnetic driver.

44. The system as set forth in claim 43 further comprising other vessels for holding reaction mixtures, other magnetic drivers associated with the respective said other vessels, and other drive shafts adapted to couple with the respective said other magnetic drivers,
said system further comprising a drive train coupled with said drive shafts for rotating said drive shafts.

45. The apparatus as set forth in claim 34 further comprising other vessels for holding reaction mixtures for use in a parallel reactor, wherein the apparatus is capable of parallel processing of the reaction mixtures.

46. A stirrer for use in a reactor, said stirrer comprising:
a spindle adapted to be mounted in a vessel for rotation on a longitudinal axis of the spindle,
a stirring implement on the spindle and rotatable therewith for contacting a reaction mixture in said vessel;
first and second magnetic followers comprising at least two spaced-apart permanent magnets rotatable with said spindle and said at least one stirring implement; and
a flux guide between said spaced-apart permanent magnets and rotatable therewith for guiding magnetic flux between said at least two spaced-apart permanent magnets,
said at least two spaced-apart permanent magnets being arranged such that when they are subjected to a rotating magnetic field, said stirrer is adapted to rotate in said vessel to mix the reaction mixture.

47. The stirrer as set forth in claim 46 wherein the first and second magnetic followers have magnetic pole axes which are not collinear.

48. The stirrer as set forth in claim 46 wherein said stirring implement encloses said at least two spaced-apart permanent magnets.

49. The stirrer as set forth in claim 48 wherein said stirring implement comprises at least two stirring elements extending from said spindle, one of said stirring elements enclosing one of the permanent magnets and another of said stirring elements enclosing another of the permanent magnets.

50. The stirrer as set forth in claim 49 further comprising at least one paddle extending from said spindle.

51. The stirrer as set forth in claim 46 wherein said a stirring implement encloses said at least two permanent magnets,
said stirring implement comprising
a hub on the spindle and
at least four mixing arms projecting generally laterally from the hub.

52. The stirrer as set forth in claim 51 wherein each of said mixing arms follows a circular path as the stirrer rotates, said mixing arms having at least one substantially planar face oriented substantially perpendicular to said circular path whereby movement of said substantially planar face through the reaction mixture in the vessel creates high shear forces within the reaction mixture in the vessel.

53. The stirrer as set forth in claim 51 further comprising a second stirring implement on said spindle,
said second stirring implement comprising a hub and at least two blades projecting generally laterally from said hub.

54. The stirrer as set forth in claim 53 wherein each of said blades follows a circular path as the stirrer rotates,
each of said blades including at least one substantially planar face oriented substantially perpendicular to said circular path whereby movement of said substantially planar face through the reaction mixture in the vessel creates high shear forces within the reaction mixture in the vessel.

55. The stirrer as set forth in claim 46 wherein said a stirring implement encloses said at least two permanent magnets,
said stirring implement having a substantially U-shaped configuration, including a base adjacent a bottom end of the spindle.

56. The stirrer as set forth in claim 55 wherein said stirring implement further comprises at least two upstanding arms oriented generally parallel to the spindle and extending upward from said base.

57. A stirrer for use in a reactor, said stirrer comprising:
a spindle adapted to be mounted in a vessel for rotation on a longitudinal axis of the spindle;
a helical blade on the spindle;
at least two stirring elements projecting from said spindle; and
at least two magnets sealed inside said stirring elements positioned and configured such that subjecting the magnets to a rotating magnetic field induces rotation of the stirrer.

58. An apparatus for processing of reaction mixtures comprising:
a base;
a vessel support mounted on the base;
a vessel supported by said vessel support;
a cap; and
a head for holding said cap,
said cap being movable with said head between a first position in which the cap sealingly engages the vessel support to seal the vessel in the vessel support, and
a second position in which the cap is clear of the vessel support to provide access to the vessel.

59. The apparatus as set forth in claim 58 further comprising a device for effecting relative movement between the head and the base thereby to move the cap between said first and second positions.

60. The apparatus as set forth in claim 59 wherein said base is stationary and said head is movable with respect to said base.

61. The apparatus as set forth in claim 60 further comprising a vessel/bearing/stirrer assembly received in said vessel support, said assembly comprising
said vessel,
a bearing supported in said vessel, and
a stirrer rotatable in the bearing,
said assembly being removable from the vessel support and replaceable by another of said assemblies.

62. The apparatus as set forth in claim 61 wherein said stirrer comprises a spindle rotatable in said bearing and
at least one stirring implement on the spindle for contacting the reaction mixture,
said stirrer further comprising at least one magnet mounted on said stirrer adapted to be subjected to a rotating magnetic field in the vessel for causing said stirrer to rotate thereby to mix the reaction mixture.

63. The apparatus as set forth in claim 59 wherein said cap and said head have cooperating registration elements for orienting the cap relative to the head.

64. The apparatus as set forth in claim 63 further comprising a cap retainer adapted for releasable connection with said head for retaining said cap in position on the head.

65. The apparatus as set forth in claim 59 further comprising an extractor adapted to be mounted on said head adjacent said cap for extraction of the cap from the head.

66. The apparatus as set forth in claim 65 wherein said extractor maintains the orientation of the cap relative to a respective vessel support during lifting of said cap.

67. The apparatus as set forth in claim 58 further comprising other vessels for holding reaction mixtures and other caps to seal or provide access to the respective said other vessels, wherein the apparatus is capable of parallel processing of reaction mixtures.

68. An apparatus for processing of a reaction mixture comprising:
a reactor module comprising:
a reactor for containing a reaction mixture;
a vessel platform for mounting the reactor;
a head movable with respect to the vessel platform, said head carrying a cap corresponding to the reactor, said head being movable between a raised position and a lowered position in which the cap carried by the head sealingly engages the reactor; and
an enclosure for enclosing the reactor module, said enclosure comprising a framework supporting the reactor module and walls enclosing the framework and reactor module.

69. The apparatus as set forth in claim 68 wherein said enclosure further comprises:
an opening in at least one of said walls; and
at least one door extending across said opening, said door being movable between an open position for accessing the reactor module within the enclosure and a closed position for enclosing said reactor module.

70. The apparatus as set forth in claim 69 wherein said framework further comprises at least one track, said reactor module being slidable on said at least one track for sliding movement of the reactor module through the opening of the enclosure.

71. The apparatus as set forth in claim 70 further comprising a plurality of reactor modules enclosed in said enclosure.

72. The apparatus as set forth in claim 68 further comprising other reactors for containing reaction mixtures and other caps corresponding to respective said other reactors, wherein the apparatus is capable of parallel processing of reaction mixtures.

73. A method of making and characterizing materials comprising the steps of:
providing a vessel support with starting materials to form a reaction mixture;
confining the reaction mixture in the vessel support at a pressure other than ambient pressure with a cap sealing said vessel support; and
controlling at least one heater associated with the cap to control the temperature of the cap and the headspace within the vessel support above the reaction mixture for at least a portion of the confining step.

74. The method as set forth in claim 73 further comprising controlling at least one temperature control device associated with the vessel support to control the temperature of the reaction mixture in the vessel support for at least a portion of the confining step.

75. The method as set forth in claim 73 further comprising providing vessel supports with starting materials to form reaction mixtures and confining the reaction mixtures in each respective vessel support against fluid communication with the other vessel supports.

76. The method as set forth in claim 73 further comprising stirring the reaction mixture for at least a portion of the confining step.

77. A stirring system for use in a reactor, said system comprising:
at least one vessel for holding a reaction mixture for processing, said at least one vessel having a convex bottom surface;
a stirrer in the at least one vessel, said stirrer comprising at least one stirring element and a magnetic follower sealed inside said stirring element; and
a drive mechanism for generating a rotating magnetic field in the at least one vessel to rotate the stirrer and thereby mix the reaction mixture,
said drive mechanism comprising a rotatable magnetic driver associated with said at least one vessel to generate said rotating magnetic field in the vessel, said rotatable magnetic driver comprising a first concave surface facing said convex bottom surface of the at least one vessel, said surfaces having substantially the same shape to maintain a substantially uniform spacing therebetween.

78. The stirring system as set forth in claim 77 wherein said at least one vessel comprises multiple vessels, each having one of said stirrers therein.

79. A stirring system for use in a reactor, said system comprising:
at least one vessel for holding a reaction mixture for processing;
a stirrer in the at least one vessel, said stirrer comprising first and second magnetic followers and a flux guide for guiding magnetic flux between the first magnetic follower and the second magnetic follower; and
a drive mechanism for generating a rotating magnetic field in the at least one vessel to rotate the stirrer and thereby mix the reaction mixture.

80. The stirring system as set forth in claim 79 wherein said at least one vessel comprises multiple vessels, each having one of said stirrers therein.
